(19) United States
(12) Patent Application Publication
(10) Pub. No.: US 2025/0229117 A1
(43) Pub. Date: Jul. 17, 2025

(54) FIREFIGHTING COMPOSITION WITH QUATERNARY FUNCTIONAL COPOLYMER

(71) Applicant: Tyco Fire Products LP, Cranston, RI (US)

(72) Inventors: Benjamin J. Markovitz, Howard, WI (US); Amy J. Wirth, Menominee, MI (US)

(73) Assignee: Tyco Fire Products LP, Cranston, RI (US)

(21) Appl. No.: 18/703,059

(22) PCT Filed: Jan. 24, 2023
(86) PCT No.: PCT/IB2023/050607

§ 371 Date: Apr. 19, 2024

Related U.S. Application Data
(60) Provisional application No. 63/303,553, filed on Jan. 27, 2022.

(51) Int. Cl. A62D 1/02

(52) U.S. Cl. CPC A62D 1/0071

(57) ABSTRACT

An aqueous concentrate, which can be diluted with an aqueous diluent to form a foam precursor composition, is provided. The foam precursor composition may be aerated to form a firefighting foam. The present aqueous firefighting composition includes a quaternary amine-substituted cationic polymer; and optionally a surfactant component, that includes one or more of an anionic surfactant, a zwitterionic surfactant, and a nonionic surfactant; and, typically, at least about 30 wt. % water.

### CROSS-REFERENCE TO RELATED APPLICATIONS

This application claims the benefit of priority to U.S. Provisional Patent Application No. 63/303,553, filed on Jan. 27, 2022, the contents of which are incorporated herein by reference in their entirety.

### BACKGROUND

Firefighting foams are often able to fight Class A and Class B fires. Class A fires are those involving combustible material such as paper, wood, etc. and can be fought by quenching and cooling with large quantities of water or solutions containing water. Class B fires are those involving flammable liquid fuels, gasoline, and other hydrocarbons. Due to the liquid nature of the fuel involved, Class B fires are difficult to extinguish. Most flammable liquids exhibit high vapor pressure along with low fire and flash points. This typically results in a wide flammability range. In this type of fire, the use of water as the sole firefighting agent is generally ineffective because the only means of fighting fire with water is through cooling.

Foaming firefighting agents are better able to combat class B fires, as they function to smother the fire and deprive it of an oxygen source. Conventional foam-forming firefighting compositions may include fluorinated and perfluorinated surfactants.

Perfluoroalkyl surfactants have been used in the preparation of aqueous fire-fighting foams (AFFFs). These surfactants are effective when used in preparing foams used to extinguish fires caused by non-polar fuels such as hydrocarbons, and act by covering the surface of the burning fuel with a vapor-suppressing film. However, such foams may be ineffective in fighting fires caused by polar solvents, such as alcohols, ketones, or tetrahydrofuran, because the foam can be destroyed by mixing with the water-miscible fuel.

So-called alcohol-resistant firefighting foams (AR-AFFFs) have been developed in response to this problem. AR-AFFF formulations contain water-soluble polymers that prevent the foam from collapsing on polar fuels and also significantly lengthen the foam drain time by increasing the viscosity of the aqueous phase. The polymers employed include polysaccharides, such as xanthan and rhamsan gums. The dissolved gum precipitates from the foam solution when it contacts the polar fuel and forms a soft mat or membrane between the foam blanket and fuel to block further intermixing. Unfortunately, the high concentrations of polysaccharide gums required for an effective AR-AFFF concentrate can often cause the concentrate to be too viscous. This can make such a concentrate difficult to pump efficiently, and therefore can cause proportioning problems during foam generation and application. The use of certain fluoropolymer surfactants has the same polar fuel performance as xanthan gums, but with much lower viscosity increase. Replacement of a significant portion of the gum by fluoropolymer surfactants has been demonstrated to provide better AR-AFFF performance. However, fluoropolymer surfactants have become associated with environmental contamination issues, leading to such materials currently being disfavored for formulating AR-AFFF concentrates.

Environmental concerns related to fluorinated and perfluorinated surfactants have developed. As a result, there is a strong desire in the marketplace to replace fluorinated and perfluorinated firefighting products with non-fluorinated products. There is accordingly a continuing need to produce non-fluorinated aqueous film-forming foam (AFFF) firefighting compositions that can be effectively deployed to fight Class B fires.

### SUMMARY

The present application is directed to aqueous firefighting compositions, typically in concentrate form, which can be diluted with an aqueous diluent to provide a foam precursor composition. The foam precursor composition may subsequently be aerated to provide a firefighting foam. In some instances, the present aqueous firefighting compositions may be used as a firefighting foam preservative additive and combined with another aqueous firefighting foam concentrate (either directly or indirectly by introducing both compositions into a flowing stream of aqueous diluent) and used to generate a firefighting foam.

The present aqueous firefighting compositions include a non-fluorinated copolymer having quaternary ammonium groups and, optionally, siloxane moieties; where the copolymer has a net cationic charge. Suitable examples of the cationic copolymer include cationic copolymers that are the polymerization product of a monomer mixture comprising a neutral vinyl monomer and a quaternary ammonium containing monomer. The monomer mixture may optionally also include a silicone-containing monomer and/or an anionic monomer. Other suitable examples of the cationic copolymer include copolymers including polymerized units derived from a mixture comprising: (i) a water-soluble (meth) acrylamide monomer; (ii) a cationic monomer comprising a quaternary ammonium salt; (iii) optionally, a silicone-containing monomer; and (iv) optionally, an anionic monomer containing at least one carboxylate and/or sulfonate group.

The present aqueous firefighting compositions may include a non-fluorinated copolymer having quaternary ammonium groups and siloxane moieties; wherein the polymer has a net cationic charge. The composition may desirably be substantially free of any fluorinated additive, e.g., contain no more than 0.1 wt. % and preferably no more than 0.01 wt. % fluorinated additive(s) and, often, is completely free of any fluorinated surfactant or other fluorinated additive. The copolymer may include the polymerization product of a monomer mixture comprising a neutral vinyl monomer and a quaternary ammonium containing monomer, in such a combination that the resulting polymer still has a net cationic charge.

An illustrative embodiment provides an aqueous firefighting composition including a copolymer formed from a mixture including a neutral vinyl monomer, that includes a (meth)acrylamide monomer, an N-vinylformamide monomer, and/or (meth)acrylate monomer; and a quaternary ammonium containing monomer, that includes a quaternary ammonium substituted (meth)acrylamide monomer and/or a quaternary ammonium substituted (meth)acrylate monomer and/or a quaternary ammonium substituted allyl monomer. The (meth)acrylamide monomer includes one or more of an N,N-dialkyl acrylamide, an N-alkyl acrylamide, an N,N-dialkyl methacrylamide, an N-alkyl methacrylamide and acrylamide; such as for example, N,N-dimethyl acrylamide, N,N-diethyl acrylamide, N-isopropyl acrylamide, N-isobutyl acrylamide, N-t-butyl acrylamide and acrylamide. The (meth)acrylate monomer includes, one or more of an alkyl acrylate, an alkyl methacrylate, a dialkylaminoalkyl acrylate and a dialkylaminoalkyl methacrylate; such as for example methyl acrylate, methyl methacrylate, ethyl acrylate, ethyl methacrylate, propyl acrylate, propyl methacrylate, butyl acrylate, butyl methacrylate, octyl acrylate, lauryl methacrylate, dimethylaminoethyl acrylate, and dimethylaminoethyl methacrylate. The quaternary ammonium containing monomer includes a quaternary ammonium substituted (meth)acrylamide monomer and/or a quaternary ammonium substituted (meth)acrylate monomer and/or a quaternary ammonium substituted allyl monomer; such as for example (acrylamidoalkyl)trialkylammonium salt, a (methacrylamidoalkyl)trialkylammonium salt, an (acryloyloxyalkyl)trialkylammonium salt and a (methacryloyloxyalkyl)trialkylammonium salt. Illustrative quaternary ammonium containing monomer includes one or more of (3-acrylamidopropyl)trimethylammonium chloride (APTAC), (3-methacrylamidopropyl) trimethylammonium chloride (MAPTAC), [2-(acryloyloxy)ethyl]trimethylammonium chloride (AETAC), [3-(methacryloyloxy)-propyl]trimethylammonium chloride (MAETAC).

Another illustrative embodiment provides an aqueous firefighting composition including a polymerization product of a monomer mixture comprising a neutral vinyl monomer, a quaternary ammonium containing monomer and a siloxane substituted vinyl monomer. The siloxane substituted vinyl monomer includes a siloxane substituted (meth)acrylate monomer and/or a siloxane substituted (meth)acrylamide monomer; such as for example, one or more of 3-[tris(trimethylsiloxy)silyl]propyl methacrylate, 3-trimethoxysilylpropyl 2-methylprop-2-enoate, 3-[tris(trimethylsiloxy)silyl]propyl acrylate, N-[tris(trimethylsiloxy) silylpropyl]-(meth)acrylamide, N-[tris(dimethylpropylsiloxy)-silylpropyl](meth)acrylamide, N-[tris(dimethylphenylsiloxy)-silylpropyl](meth)acrylamide, and N-[tris(dimethylethylsiloxy) silylpropyl](meth)acrylamide.

Another illustrative embodiment provides an aqueous firefighting composition including a polymerization product of a monomer mixture comprising a neutral vinyl monomer, a quaternary ammonium containing monomer, a siloxane substituted vinyl monomer and an anionic vinyl monomer. The anionic vinyl monomer includes a vinyl monomer having one or more carboxylic acid and/or sulfonic acid groups or salts thereof; such as for example, one or more of acrylic acid, sodium methacrylate, methacrylic acid, sodium methacrylate, potassium 3-sulfopropyl acrylate, sodium 3-sulfopropyl methacrylate, 2-acrylamido-2-methyl-1-propanesulfonic acid, potassium 2-acrylamido-2-methyl-1-propanesulfonate (K-AMPS), 2-methacrylamido-2-methyl-1-propanesulfonic acid sodium salt and 2-acrylamido-2-methyl-1-propanesulfonic acid sodium salt (Na-AMPS).

The aqueous firefighting compositions may further include one or more surfactants selected from the group consisting of a nonionic surfactant, an anionic surfactant, a zwitterionic surfactant, an amphoteric surfactant, and combinations thereof.

Another illustrative embodiment provides an aqueous firefighting composition that includes a non-fluorinated copolymer having quaternary ammonium groups and siloxane moieties; a water-miscible organic solvent; and one or more surfactants selected from the group consisting of a nonionic surfactant, an anionic surfactant, and a zwitterionic surfactant.

Another illustrative embodiment provides an aqueous firefighting composition that includes a non-fluorinated copolymer having quaternary ammonium groups and siloxane moieties; an alkyl polysaccharide and/or aliphatic alcohol-based surfactant; an alkyl sulfate and/or alkyl ether sulfate surfactant; and a water-miscible organic solvent comprising an alkylene glycol, and/or an alkylene glycol ether.

Another illustrative embodiment provides an aqueous firefighting composition that includes a non-fluorinated copolymer having quaternary ammonium groups and siloxane moieties; an alkyl sulfate and/or alkyl ether sulfate surfactant; an alkylamidoalkyl hydroxysultaine surfactant and/or alkyl betaine surfactant; and a water-miscible organic solvent comprising an alkylene glycol, and/or an alkylene glycol ether.

Another illustrative embodiment provides an aqueous firefighting composition as described above, further including one or more of: (a) a polysaccharide thickener, such as diutan gum and/or xanthan gum; (b) a sugar component, which comprises monosaccharide sugar (e.g., glucose and/or fructose) and/or sugar alcohol (e.g., sorbitol, mannitol and/or xylitol); c) divalent cation salt; and (d) an additive including one or more of a preservative, a corrosion inhibitor, an alkanolamine, and a pH adjusting agent.

An aqueous firefighting foam precursor can be formed by diluting the concentrated composition described herein with a much larger volume of an aqueous diluent, e.g., municipal water and/or salt water. The resulting firefighting foam precursor can then be aerated to provide a firefighting foam.

The aqueous firefighting compositions are designed to meet UL162, Class B performance criteria for at least one of AFFF agents and fluoroprotein (FP) agents without requiring any fluorinated additive. Accordingly, an illustrative embodiment provides a method of fighting a fire, that includes forming a foam comprising the aqueous firefighting composition, and applying the foam directly or indirectly onto the fire, such as a class B fire.

Another illustrative embodiment provides an aqueous firefighting composition including (a) a cationic copolymer comprising polymerized units derived from a mixture that includes (i) a water-soluble (meth)acrylamide monomer, (ii) a cationic monomer comprising a quaternary ammonium salt, and (iii) optionally, a silicone-containing monomer, and (iv) optionally, an anionic monomer containing at least one carboxylate and/or sulfonate group; (b) a surfactant component comprising anionic surfactant and nonionic surfactant; (c) water-miscible organic solvent comprising an alkylene glycol and/or an alkylene glycol ether; and (d) divalent cation salt; the composition being substantially free of fluorinated additives.

Another illustrative embodiment provides an aqueous firefighting composition including (a) a cationic copolymer comprising polymerized units derived from a mixture that includes (i) a water-soluble (meth)acrylamide monomer, (ii) a cationic monomer comprising a quaternary ammonium salt, and (iii) optionally, a silicone-containing monomer, and (iv) optionally, an anionic monomer containing at least one carboxylate and/or sulfonate group; (b) a surfactant component comprising anionic surfactant and zwitterionic surfactant; and (c) a sugar component; the composition being substantially free of fluorinated additives.

Another illustrative embodiment provides an aqueous firefighting composition including (a) a cationic polymer comprising polymerized units derived from a mixture that includes (i) a water-soluble (meth)acrylamide monomer, (ii) a cationic monomer comprising a quaternary ammonium salt, and (iii) optionally, a silicone-containing monomer, and (iv) optionally, an anionic monomer containing at least one carboxylate and/or sulfonate group; (b) a surfactant component; and (c) a polysaccharide thickener; the composition being substantially free of fluorinated additives.

Another illustrative embodiment provides an aqueous firefighting composition including a cationic polymer comprising polymerized units derived from a mixture that includes (i) a water-soluble (meth)acrylamide monomer, (ii) a cationic monomer comprising a quaternary ammonium salt, and (iii) a silicone-containing monomer, and (iv) optionally, an anionic monomer containing at least one carboxylate and/or sulfonate group.

Another illustrative embodiment provides an aqueous firefighting composition including a cationic polymer comprising polymerized units derived from a mixture that includes (i) a water-soluble (meth)acrylamide monomer, (ii) a cationic monomer comprising a quaternary ammonium salt, and (iii) a silicone-containing monomer, and (iv) an anionic monomer containing at least one carboxylate and/or sulfonate group.

Another illustrative embodiment provides an aqueous firefighting composition including a cationic polymer comprising polymerized units derived from a mixture that includes (i) a water-soluble (meth)acrylamide monomer, (ii) a cationic monomer comprising a quaternary ammonium salt, and (iii) an anionic monomer containing at least one carboxylate and/or sulfonate group.

In an embodiment, the anionic monomer comprises an anionic vinyl monomer. In an embodiment, the anionic vinyl monomer may suitably include a vinyl monomer having one or more carboxylic acid and/or sulfonic acid groups or salts thereof. In an embodiment, the anionic vinyl monomer may include, without limitation, acrylic acid, methacrylic acid, 2-acrylamido-2-methylpropanesulfonic acid, 2-methyl acrylamido-2-methylpropanesulfonic acid, and sodium, potassium or ammonium salts of these acids. In an embodiment, the anionic vinyl monomer may include, without limitation, one or more of acrylic acid, sodium methacrylate, methacrylic acid, sodium methacrylate, potassium 3-sulfopropyl acrylate, sodium 3-sulfopropyl methacrylate, 2-acrylamido-2-methyl-1-propanesulfonic acid, potassium 2-acrylamido-2-methyl-1-propanesulfonate (K-AMPS), 2-methacrylamido-2-methyl-1-propanesulfonic acid sodium salt and 2-acrylamido-2-methyl-1-propanesulfonic acid sodium salt (Na-AMPS).

Another illustrative embodiment provides an aqueous firefighting composition including a cationic copolymer including polymerized units derived from a mixture including (i) N,N-dimethylacrylamide and/or N-isopropylacrylamide, (ii) (3-acrylamidopropyl)trimethyl ammonium chloride and/or (2-acrylamidoethyl)trimethyl ammonium chloride, and (iii) optionally 3-[tris(trimethylsiloxy)silyl]propyl methacrylate. In an embodiment, the mole ratio of the monomers (i), (ii) and (iii) is about 1.0:0.05 to 1.0:0.005 to 0.15.

Another illustrative embodiment provides an aqueous firefighting composition including a cationic polymer derived from polymerizing monomers including (i) N,N-dimethylacrylamide; and (ii) (3-methacrylamidopropyl)trimethyl ammonium chloride. In an embodiment, the mole ratio of the monomers (i) to (ii) is 1.0 to about 0.05-1.0.

Another illustrative embodiment provides an aqueous firefighting composition including a cationic polymer derived from polymerizing monomers including (i) N,N-dimethylacrylamide; (ii) (3-methacryl-amidopropyl)-trimethyl ammonium chloride; and (iii) 3-[tris(trimethylsiloxy)silyl]-propyl methacrylate. In an embodiment, the mole ratio of the monomers (i), (ii), and (iii) is about 1.0:0.05 to 1.0:0.005 to 0.15.

Another illustrative embodiment provides an aqueous firefighting composition including a cationic polymer derived from polymerizing monomers including (i) N,N-dimethylacrylamide; (ii) (3-acrylamidopropyl)trimethyl ammonium chloride; (iii) 3-[tris(trimethylsiloxy)silyl]propyl methacrylate; and (iv) acrylamide. In an embodiment, the mole ratio of the monomers (i), (ii), (iii) and (iv) is about 1.0:0.1 to 0.5:0.02 to 0.15:0.5-2.5.

Another illustrative embodiment provides an aqueous firefighting composition including (a) a cationic polymer comprising polymerized units derived from monomers that includes (i) N,N-dimethylacrylamide and acrylamide, (ii) (3-acrylamidopropyl)trimethyl ammonium chloride and/or (2-acrylamidoethyl)trimethyl ammonium chloride, and (iii) optionally 3-[tris(trimethylsiloxy)silyl]propyl methacrylate.

Another illustrative embodiment provides an aqueous firefighting composition including (a) a cationic copolymer comprising polymerized units derived from a mixture that includes (i) a water-soluble (meth)acrylamide monomer, (ii) an N-vinylformamide monomer, (iii) a cationic monomer comprising a quaternary ammonium salt, and (iv) a silicone-containing monomer, and (v) optionally, an anionic monomer containing at least one carboxylate and/or sulfonate group; (b) a surfactant component comprising anionic surfactant and nonionic surfactant; (c) water-miscible organic solvent comprising an alkylene glycol and/or an alkylene glycol ether; and (d) divalent cation salt; the composition being substantially free of fluorinated additives.

Another illustrative embodiment provides an aqueous firefighting composition including (a) a cationic copolymer comprising polymerized units derived from a mixture that includes (i) a water-soluble (meth)acrylamide monomer, (ii) an N-vinylformamide monomer, (iii) a cationic monomer comprising a quaternary ammonium salt, and (iv) a silicone-containing monomer, and (v) optionally, an anionic monomer containing at least one carboxylate and/or sulfonate group; (b) a surfactant component comprising anionic surfactant and zwitterionic surfactant; and (c) a sugar component; the composition being substantially free of fluorinated additives.

Another illustrative embodiment provides an aqueous firefighting composition including (a) a cationic polymer comprising polymerized units derived from a mixture that includes (i) a water-soluble (meth)acrylamide monomer, (ii) an N-vinylformamide monomer, (iii) a cationic monomer comprising a quaternary ammonium salt, and (iv) a silicone-containing monomer, and (v) optionally, an anionic monomer containing at least one carboxylate and/or sulfonate group; (b) a surfactant component; and (c) a polysaccharide thickener; the composition being substantially free of fluorinated additives.

Another illustrative embodiment provides an aqueous firefighting composition including a cationic polymer derived from polymerizing monomers including (i) N,N-dimethylacrylamide; (ii) N-vinylformamide, (iii) (3-methacryl-amidopropyl)-trimethyl ammonium chloride; and (iv) 3-[tris(trimethylsiloxy)silyl]-propyl methacrylate. In an embodiment, the mole ratio of the monomers (i), (ii), (iii), and (iv) is about 1:0.05-3.5:0.05-0.50:0.015, including about 1.0:1.09:0.18:0.09, including about 1.0:1.5:0.2:0.15, including about 1.0:2.0:0.3:0.15, including about 1.0:2.5:0.4:0.15, including about 1.0:3.5:0.5:0.15, including about 1.0:1.0:0.1:0.1, including about 1.0:0.5:0.05:0.05, including about 1.0:0.3:0.05:0.05, including about 1.0:0.1:0.05:0.05, or about 1.0:0.05:0.05:0.05, and ratios in between and including these values.

In some aspects, the aqueous firefighting foam compositions of the present disclosure may include a sugar component, e.g., a monosaccharide sugar and/or sugar alcohol; polysaccharide thickener; a surfactant component, which comprises anionic surfactant, zwitterionic surfactant and/or an aliphatic alcohol-based nonionic surfactant; a water-miscible organic solvent; and at least about 30 wt. % water.

The aqueous firefighting compositions described above may suitably also include one or more other additives of the type found in firefighting foam concentrates. For example, the firefighting compositions may include one or more of the following:
a surfactant component;
a polysaccharide thickener;
a water-miscible solvent;
a sugar component; and
a divalent metal salt, such as a magnesium salt.
   The surfactant component may include one or more of an anionic surfactant, e.g., an alkyl sulfate and/or alkyl ether sulfate surfactant; a zwitterionic surfactant, e.g., an aliphatic amidoalkyl hydroxysultaine surfactant and/or aliphatic betaine surfactant; and a nonionic surfactant, e.g., an alkylpolyglycoside and/or an aliphatic alcohol-based surfactant. Examples of suitable water-miscible solvents include glycol solvents, glycol ether solvents, glycerol, and water-soluble polyethylene glycols. The aqueous firefighting compositions may be substantially free of fluorinated additives and in many instances contain a total of no more than about 0.1 wt. % fluorinated additives. The aqueous firefighting compositions may also include one or more additional additives, such as a preservative, a corrosion inhibitor, and/or a pH adjusting agent. In many instances, the firefighting composition includes a pH-adjusting agent, such as an alkanolamine.

The present aqueous firefighting compositions may be used to form firefighting foams. Typically, the present aqueous firefighting composition in the form of a concentrate is diluted with an aqueous diluting agent to provide a foam precursor solution. Suitable aqueous diluting agents include one or more of municipal water, brackish water and salt water. The foam precursor solution is then aerated to provide the firefighting foam. The firefighting foam may be used to secure a hazard, such as a liquid hydrocarbon or organic solvent fire by applying the firefighting foam directly or indirectly onto the hazard to extinguish fire and/or suppress flammable vapors. The present aqueous firefighting foams may be particularly useful when the fire is a class B fire.

### DETAILED DESCRIPTION

The present technology provides firefighting compositions, e.g., aqueous firefighting concentrates, without requiring a fluorine component or having no added fluorochemical surfactants or fluorinated polymers. The present aqueous firefighting compositions may advantageously be substantially free of any fluorinated additives. As used herein, the “phrase substantially free of fluorinated additives” means that the aqueous firefighting composition includes no more than 0.1 wt. % fluorinated additives. In some embodiments, the aqueous firefighting composition includes no more than 0.01 wt. % and, in some instances, no more than about 0.005 wt. % fluorinated additives. The aqueous firefighting compositions of the present disclosure may be substantially free of fluorine in any form. As used herein, the phrase “substantially free of fluorine” means that the aqueous firefighting composition has no intentionally added fluorine and, in some instances, may have a total concentration of fluorine atoms on a weight percentage basis of no more than about 1 ppm F.

The present application is directed to aqueous firefighting compositions that may be provided in a foam concentrate form, which can be diluted with an aqueous diluent to provide a foam precursor composition, which may be aerated to form a firefighting foam.

In one aspect, the aqueous firefighting compositions may include a non-fluorinated copolymer having quaternary ammonium groups and siloxane moieties, wherein the polymer has a net cationic charge. Such a copolymer is essentially fluorine-free and may include the polymerization product of a monomer mixture comprising a neutral vinyl monomer and a quaternary ammonium containing monomer, in such a combination that the resulting polymer still has a net cationic charge.

In an embodiment, the compositions may include from about 0.1 wt. % to about 50 wt. %, including from about 0.5 wt. % to about 25 wt. %, about 1 wt. % to about 10 wt. %, about 1 wt. % to about 5 wt. %, and about 0.5 wt. % to about 3 wt. %, of a non-fluorinated copolymer having quaternary ammonium groups and siloxane moieties, based on the total weight of the composition.

In an embodiment of the present technology, the monomer mixture of the present technology includes a neutral vinyl monomer. The neutral vinyl monomer may include a (meth)acrylamide monomer, an N-vinylformamide monomer, and/or (meth)acrylate monomer. In an embodiment, the (meth)acrylamide monomer may include one or more of alkyl (meth)acrylamide and dialkyl (meth)acrylamide including, without limitation, an N,N-dialkyl acrylamide, an N-alkyl acrylamide, an N,N-dialkyl methacrylamide, an N-alkyl methacrylamide and acrylamide. In an embodiment, the alkyl group may include, without limitation, one or more of methyl, ethyl, n-propyl, iso-propyl, n-butyl, iso-butyl, sec-butyl, tert-butyl, n-pentyl, hexyl, heptyl, octyl, lauryl, and cetyl. Suitable (meth)acrylamide monomers include, without limitation, one or more of acrylamide, N,N-dimethyl acrylamide, N,N-diethyl acrylamide, N-ethyl-N-methyl-acrylamide, N-isopropyl acrylamide, N,N-dipropyl acrylamide, N,N-diisopropyl acrylamide, N-methyl-N-propyl-acrylamide, N-isobutyl acrylamide, N-t-butyl acrylamide, N,N-dibutyl acrylamide, N,N-dimethyl methacrylamide, N,N-dibutyl methacrylamide, and the like and their derivatives. In an embodiment, the (meth)acrylamide monomer may include one or more of N,N-dimethyl acrylamide, N,N-diethyl acrylamide, N-isopropyl acrylamide, N-isobutyl acrylamide, N-t-butyl acrylamide, and acrylamide.

In an embodiment of the present technology, the monomer mixture of the present technology includes an N-vinylformamide monomer. In an embodiment, the N-vinylformamide monomer may include one or more of N-vinylformamide monomers or suitable derivatives or salts thereof. In an embodiment, the N-vinylformamide monomer derivative includes an N-alkyl-N-vinylformamide monomer, such as N-methyl-N-vinylformamide, N-ethyl-N-vinylformamide, and the like.

In an embodiment of the present technology, the monomer mixture of the present technology includes a (meth)acrylate monomer. In an embodiment, the (meth)acrylate monomer may include one or more of alkyl (meth)acrylate, dialkyl (meth)acrylate, alkylaminoalkyl (meth)acrylate, and dialkylaminoalkyl (meth)acrylate including, without limitation, an alkyl acrylate, an alkyl methacrylate, a dialkylaminoalkyl acrylate and a dialkylaminoalkyl methacrylate. In an embodiment, the alkyl group may include, without limitation, one or more of methyl, ethyl, n-propyl, iso-propyl, n-butyl, iso-butyl, sec-butyl, tert-butyl, n-pentyl, hexyl, heptyl, octyl, lauryl, and cetyl. Suitable (meth)acrylate monomers include, without limitation, one or more of methyl acrylate, methyl methacrylate, ethyl acrylate, ethyl methacrylate, propyl acrylate, propyl methacrylate, butyl acrylate, butyl methacrylate, hexyl methacrylate, 2-ethylhexyl acrylate, octyl acrylate, octyl methacrylate, lauryl acrylate, lauryl methacrylate, dimethylaminoethyl methacrylate, dimethylaminoethyl acrylate. In an embodiment, the (meth)acrylate monomer may include one or more of methyl acrylate, methyl methacrylate, ethyl acrylate, ethyl methacrylate, propyl acrylate, propyl methacrylate, butyl acrylate, butyl methacrylate, octyl acrylate, lauryl methacrylate, dimethylaminoethyl acrylate, and dimethylaminoethyl methacrylate.

In an embodiment of the present technology, the monomer mixture of the present technology includes a quaternary ammonium containing monomer. The quaternary ammonium group generally has formula —N⁺R₂X⁻— or —N⁺R₃X⁻, wherein each R independently can be selected from optionally substituted C₁-C₁₂ alkyl group or a C₆-C₁₂ aryl group, and X is a halogen atom, e.g., Cl, Br or I. In an embodiment, the quaternary ammonium containing monomer includes one or more of a quaternary ammonium substituted (meth)acrylamide monomer and/or a quaternary ammonium substituted (meth)acrylate monomer and/or a quaternary ammonium substituted allyl monomer. Suitable quaternary ammonium substituted monomers include, without limitation, one or more of an (acrylamidoalkyl)trialkylammonium salt, a (methacrylamidoalkyl)trialkylammonium salt, an (acryloyloxyalkyl)trialkylammonium salt and a (methacryloyloxyalkyl)trialkylammonium salt. In an embodiment, the quaternary ammonium substituted (meth)acrylamide monomer and/or quaternary ammonium substituted (meth)acrylate monomer may include, without limitation one or more of (3-acrylamidopropyl) trimethylammonium chloride (APTAC), (3-methacrylamidopropyl) trimethylammonium chloride (MAPTAC), [2-(acryloyloxy)ethyl]trimethylammonium chloride (AETAC), [3-(methacryloyloxy)-propyl]trimethylammonium chloride (MAETAC).

In an embodiment of the present technology, the monomer mixture also includes a siloxane substituted monomer, such as a siloxane substituted vinyl monomer. In an embodiment, the siloxane substituted vinyl monomer may include, without limitation, a siloxane substituted (meth)acrylate monomer and/or a siloxane substituted (meth)acrylamide monomer. In an embodiment, the siloxane substituted (meth)acrylate monomer and/or a siloxane substituted (meth)acrylamide monomer includes one or more of 3-[tris(trimethylsiloxy)silyl]propyl methacrylate, 3-trimethoxysilylpropyl 2-methylprop-2-enoate, 3-[tris(trimethylsiloxy)silyl]propyl acrylate, N-[tris(trimethylsiloxy) silylpropyl]-(meth)acrylamide, N-[tris(dimethylpropylsiloxy)-silylpropyl](meth)acrylamide, N-[tris(dimethylphenylsiloxy)-silylpropyl](meth)acrylamide, and N-[tris(dimethylethylsiloxy) silylpropyl](meth)acrylamide.

In an embodiment of the present technology, the monomer mixture of the present technology further includes an anionic monomer, such as an anionic vinyl monomer. In an embodiment, the anionic vinyl monomer may suitably include a vinyl monomer having one or more carboxylic acid and/or sulfonic acid groups or salts thereof. In an embodiment, the anionic vinyl monomer may include, without limitation, acrylic acid, methacrylic acid, 2-acrylamido-2-methylpropanesulfonic acid, 2-methyl acrylamido-2-methylpropanesulfonic acid, and sodium, potassium or ammonium salts of these acids. In an embodiment, the anionic vinyl monomer may include, without limitation, one or more of acrylic acid, sodium methacrylate, methacrylic acid, sodium methacrylate, potassium 3-sulfopropyl acrylate, sodium 3-sulfopropyl methacrylate, 2-acrylamido-2-methyl-1-propanesulfonic acid, potassium 2-acrylamido-2-methyl-1-propanesulfonate (K-AMPS), 2-methacrylamido-2-methyl-1-propanesulfonic acid sodium salt and 2-acrylamido-2-methyl-1-propanesulfonic acid sodium salt (Na-AMPS).

Another illustrative embodiment provides a non-fluorinated copolymer having quaternary ammonium groups and siloxane moieties; wherein the polymer has a net cationic charge. Such a copolymer may be the polymerization product of a monomer mixture comprising a neutral vinyl monomer and a quaternary ammonium containing monomer. The neutral vinyl monomer may include a (meth)acrylamide monomer, an N-vinylformamide monomer and/or (meth)acrylate monomer. Suitable (meth)acrylamide monomers include one or more of an N,N-dialkyl acrylamide, an N-alkyl acrylamide, an N,N-dialkyl methacrylamide, an N-alkyl methacrylamide and acrylamide. Suitable (meth)acrylate monomers include one or more of an alkyl acrylate, an alkyl methacrylate, a dialkylaminoalkyl acrylate and a dialkylaminoalkyl methacrylate. The quaternary ammonium containing monomer may include a quaternary ammonium substituted (meth)acrylamide monomer and/or a quaternary ammonium substituted (meth)acrylate monomer and/or a quaternary ammonium substituted allyl monomer. Suitable quaternary ammonium substituted monomers include one or more of an (acrylamidoalkyl)trialkylammonium salt, a (methacrylamidoalkyl)trialkylammonium salt, a (methacryloyloxyalkyl)trialkylammonium salt and a (acryloyloxyalkyl)trialkylammonium salt. The monomer mixture also includes a siloxane substituted monomer, such as a siloxane substituted vinyl monomer. Suitable siloxane substituted vinyl monomers include siloxane substituted (meth)acrylate monomers and/or a siloxane substituted (meth)acrylamide monomers.

An illustrative embodiment provides aqueous firefighting compositions which include a cationic copolymer containing polymerized units derived from a mixture, that includes (i) a water-soluble (meth)acrylamide monomer, (ii) a cationic monomer comprising a quaternary ammonium salt, and (iii) optionally, a silicone-containing monomer, and (iv) optionally, an anionic monomer containing at least one carboxylate and/or sulfonate group.

Another illustrative embodiment provides aqueous firefighting compositions which include a cationic copolymer containing polymerized units derived from a mixture, that includes (i) a water-soluble (meth)acrylamide monomer, (ii) an N-vinylformamide monomer, (iii) a cationic monomer comprising a quaternary ammonium salt, and (iv) a silicone-containing monomer, and (v) optionally, an anionic monomer containing at least one carboxylate and/or sulfonate group.

Another illustrative embodiment provides aqueous firefighting compositions which include a cationic copolymer containing polymerized units derived from a mixture, that includes (i) a water-soluble (meth)acrylamide monomer, (ii) a cationic monomer comprising a quaternary ammonium salt, and (iii) a silicone-containing monomer, and (iv) an anionic monomer containing at least one carboxylate and/or sulfonate group.

Another illustrative embodiment provides aqueous firefighting compositions which include a cationic copolymer containing polymerized units derived from a mixture, that includes (i) a water-soluble (meth)acrylamide monomer, (ii) an N-vinylformamide monomer, (iii) a cationic monomer comprising a quaternary ammonium salt, and (iv) a silicone-containing monomer, and (v) an anionic monomer containing at least one carboxylate and/or sulfonate group.

In an embodiment, the anionic monomer comprises an anionic vinyl monomer. In an embodiment, the anionic vinyl monomer may suitably include a vinyl monomer having one or more carboxylic acid and/or sulfonic acid groups or salts thereof. In an embodiment, the anionic vinyl monomer may include, without limitation, acrylic acid, methacrylic acid, 2-acrylamido-2-methylpropanesulfonic acid, 2-methyl acrylamido-2-methylpropanesulfonic acid, and sodium, potassium or ammonium salts of these acids. In an embodiment, the anionic vinyl monomer may include, without limitation, one or more of acrylic acid, sodium methacrylate, methacrylic acid, sodium methacrylate, potassium 3-sulfopropyl acrylate, sodium 3-sulfopropyl methacrylate, 2-acrylamido-2-methyl-1-propanesulfonic acid, potassium 2-acrylamido-2-methyl-1-propanesulfonate (K-AMPS), 2-methacrylamido-2-methyl-1-propanesulfonic acid sodium salt and 2-acrylamido-2-methyl-1-propanesulfonic acid sodium salt (Na-AMPS).

The aqueous firefighting composition may further include additional surfactants selected from the group consisting of nonionic, anionic, zwitterionic, amphoteric, ampholytic, nonionic and cationic surfactants, and mixtures thereof. In an embodiment, the compositions of the present technology further include one or more of nonionic surfactant, zwitterionic surfactant, and anionic surfactant. In an embodiment, the compositions include nonionic surfactant and anionic surfactant. In an embodiment, the compositions include nonionic surfactant and zwitterionic surfactant. In an embodiment, the compositions include zwitterionic surfactant, and anionic surfactant.

The present aqueous firefighting compositions may include a nonionic surfactant. Suitable nonionic surfactants include, without limitation, alkyl polysaccharide and/or aliphatic alcohol-based surfactants. The alkyl polysaccharides surfactants, have a hydrophobic group containing from about 8 to about 20 carbon atoms, preferably from about 10 to 16 carbon atoms, most preferably from about 12 to 14 carbon atoms, and polysaccharide hydrophilic group containing from about 1.5 to 10, preferably from about 1.5 to 4, most preferably from about 1.6 to 2.7 saccharide units (e.g., galactoside, glucoside, fructoside, glucosyl, fructosyl; and/or galactosyl units). The alkyl polysaccharide surfactants may also include mixtures of saccharide moieties. Suitable alkyl polysaccharides include, without limitation, decyl, dodecyl, tetradecyl, pentadecyl, hexadecyl, and octadecyl, di-, tri-, tetra-, penta-, and hexaglucosides, galactosides, lactosides, fructosides, fructosyls, lactosyls, glucosyls and/or galactosyls and mixtures thereof. Suitable aliphatic alcohol-based surfactants include primary and secondary aliphatic alcohol alkoxylates, alcohol ethylene oxide propylene oxide condensate (e.g., Plurafacs) and condensates of ethylene oxide with sorbitan fatty acid esters (e.g., Tweens). The alcohol-based surfactants may also include fatty alcohols (having linear or branched C₁₂-C₁₄ alkyl groups, e.g., cetyl alcohol, stearyl alcohol, oleyl alcohol), polyoxethylene or polyoxypropylene glycol alkyl or alkylphenol ethers, block copolymers of polyoxyethylene and polyoxypropylene, and others as known in the art. In an embodiment, the nonionic surfactants used in the aqueous firefighting composition include alkyl glycosides and polyglycosides surfactants. In an embodiment, the nonionic surfactants include a surfactant prepared from glucose and C₈-C₁₀ fatty alcohols. In embodiments that include the nonionic surfactant, the aqueous firefighting composition may include about 1 to 25 wt. % or about 2 to 20 wt. % of the nonionic surfactant. Typically, the aqueous firefighting composition may include about 2 to 15 wt. %, about 3 to 12 wt. % and, in some instances, about 5 to 10 wt. % of the nonionic surfactant.

In one aspect, the present aqueous firefighting foam concentrates may include an aliphatic alcohol-based component as a nonionic surfactant, such as an aliphatic alcohol and/or an aliphatic alcohol ethoxylate. For example, the concentrate may include an aliphatic alcohol-based component including an aliphatic alcohol having 8 to 14 carbon atoms or an aliphatic alcohol ethoxylate having 10 to 16 carbon atoms in its alcohol portion. Alternatively, the concentrate may include a mixture of an aliphatic alcohol having 8 to 14 carbon atoms and an aliphatic alcohol ethoxylate having 10 to 16 carbon atoms in its alcohol portion. In such mixtures, the ratio of aliphatic alcohol to aliphatic alcohol ethoxylate may be in range of about 10:1 to 1:10, or about 5:1 to 1:5, about 2:1 to 1:2, about 1.5:1 to 1:1:5, or about 1:1. The foam concentrate may suitably include about 0.1 to 5 wt. %, about 0.2 to 3 wt. %, or about 0.3 to 2 wt. % of the aliphatic alcohol-based nonionic surfactant. The aliphatic alcohol ethoxylate may have an average degree of polymerization (i.e., the average number of ethylene oxide units) of about 0.5-6.0 and often of no more than about 4.0, desirably no more than about 3.0 or no more than about 2.0. Aliphatic alcohols, which include a linear C₈₋₁₄-aliphatic alcohol, such as a C₈₋₁₄-fatty alcohol, are suitable for use as a nonionic surfactant in the present concentrates. Suitable examples of such alcohols include one or more of octyl alcohol, decyl alcohol, lauryl alcohol, and myristyl alcohol. The foam concentrate may include an aliphatic alcohol ethoxylate having an average of no more than about 3 ethylene oxide units. The aliphatic alcohol portion of such ethoxylates typically has about 10 to 16 carbon atoms. Suitable examples include decyl alcohol ethoxylates, lauryl alcohol ethoxylates, myristyl alcohol ethoxylates, and/or cetyl alcohol ethoxylates. Such ethoxylates may have an average of no more than about 3 ethylene oxide units, no more than about 2.0 ethylene oxide units, no more than about 1.5 ethylene oxide units and, in some instances, no more than about 1 ethylene oxide units. In one suitable embodiment, the aliphatic alcohol ethoxylate comprises an ethoxylate of a linear C₈₋₁₄-aliphatic alcohol having no more than about 1.2 ethylene oxide units.

The aliphatic alcohol-based component may include an aliphatic alcohol ethoxylate. The aliphatic alcohol ethoxylate may have an average degree of polymerization (i.e., the average number of ethylene oxide units) of about 0.5-6.0 and often of no more than about 4.0, desirably no more than about 3.0 or no more than about 2.0. Aliphatic alcohols, which include a linear C₈₋₁₄-aliphatic alcohol, such as a C₈₋₁₄-fatty alcohol, are suitable for use as a nonionic surfactant in the present concentrates. Suitable examples of such alcohols include one or more of octyl alcohol, decyl alcohol, lauryl alcohol, and myristyl alcohol. The foam concentrate may include an aliphatic alcohol ethoxylate having an average of no more than about 3 ethylene oxide units. The aliphatic alcohol portion of such ethoxylates typically has about 10 to 16 carbon atoms. Suitable examples include decyl alcohol ethoxylates, lauryl alcohol ethoxylates, myristyl alcohol ethoxylates, and/or cetyl alcohol ethoxylates. Such ethoxylates may have an average of no more than about 3 ethylene oxide units, no more than about 2.0 ethylene oxide units, no more than about 1.5 ethylene oxide units and, in some instances, no more than about 1 ethylene oxide units. In one suitable embodiment, the aliphatic alcohol ethoxylate comprises an ethoxylate of a linear C₈₋₁₄-aliphatic alcohol having no more than about 1.2 ethylene oxide units.

The present aqueous fire-fighting foam compositions may include an anionic surfactant. The anionic surfactant may suitably include an aliphatic sulfate surfactant, an aliphatic sulfonate surfactant, aliphatic ether sulfate surfactant, and/or an aliphatic ether sulfonate surfactant. The anionic surfactant may suitably include an alkyl sulfate surfactant, an alkyl sulfonate surfactant, alkyl ether sulfate surfactant and/or an alkyl ether sulfonate surfactant. The anionic surfactant typically includes an alkyl sulfate surfactant and/or an alkyl sulfonate surfactant. The alkyl sulfate salt surfactant typically includes include a C₈₋₁₂-alkyl sulfate salt. Suitable examples of the C₈₋₁₂-alkyl sulfate salt include a dodecyl sulfate salt (lauryl sulfate salt), a decyl sulfate salt, an octyl sulfate salt, or a combination of any two or more thereof. In some embodiments, the alkyl sulfate salt includes an alkyl sulfate sodium salt, such as a sodium decyl sulfate, sodium octyl sulfate, or a combination thereof. In some embodiments, the alkyl sulfate salt includes an alkyl sulfate ammonium salt, such as an ammonium decyl sulfate, ammonium octyl sulfate, ammonium lauryl sulfate, triethanolamine lauryl sulfate salt, or a combination thereof. In an embodiment, the anionic surfactant is selected from the group consisting of sodium lauryl sulfate, ammonium lauryl sulfate, sodium octyl sulfate, sodium decyl sulfate, sodium lauryl ether sulfate, ammonium lauryl ether sulfate, sodium lauroyl sarconisate, sodium oleylsuccinate, sodium lauryl ether sulphosuccinate, ammonium lauryl sulfosuccinate, sodium dodecylbenzol sulfonate and triethanolamine dodecylbenzol sulfonate or mixtures thereof. In embodiments that include the anionic surfactant, the aqueous firefighting composition may include about 1 to 25 wt. % or about 2 to 20 wt. % of the anionic surfactant. Typically, the aqueous firefighting composition includes about 2 to 15 wt. %, about 3 to 12 wt. % and, in some instances, about 5 to 10 wt. % of a the anionic surfactant.

In some embodiments, the aqueous fire-fighting foam composition may include an anionic surfactant comprises a C₈₋₁₄-alkyl sulfate salt and/or a C₈₋₁₄-alkyl sulfonate salt. In some embodiments, the aqueous fire-fighting foam composition may include an anionic surfactant, which comprises one or more surfactants selected from C₈₋₁₂-alkyl sulfate salts and/or a C₈₋₁₂-alkyl sulfonate salts. For example, one or more of octyl sulfate salts, decyl sulfate salts, dodecyl sulfate salts, and tetradecyl sulfate salts may be suitable for use as anionic surfactants in the present foam composition. The anionic surfactant may suitably be a sodium, potassium, and/or ammonium salt (e.g., an NH⁴⁺ or trialkyl ammonium salt).

In some embodiments, the aqueous fire-fighting foam composition may include an anionic surfactant comprising a C₈₋₁₄-alkyl sulfate amine salt. In some embodiments, the aqueous fire-fighting foam composition may include an anionic surfactant, which comprises one or more surfactants selected from C₈₋₁₂-alkyl sulfate amine salts and/or a C₈₋₁₂-alkyl sulfonate amine salts. For example, one or more of triethanolamine octyl sulfate salts, triethanolamine decyl sulfate salts, triethanolamine dodecyl sulfate salts, and triethanolamine tetradecyl sulfate salts may be suitable for use as anionic surfactants in the present fire-fighting foam composition.

The present aqueous fire-fighting foam compositions may include a zwitterionic surfactant. The zwitterionic surfactant typically includes one or more of an aliphatic amidoalkyl betaine surfactant, an aliphatic betaine surfactant, an aliphatic sulfobetaine surfactant and an aliphatic amidoalkylene hydroxysultaine surfactant, such as an aliphatic amidopropyl hydroxysultaine surfactant. The zwitterionic surfactant may include one or more of an alkylamidoalkyl betaine surfactant, an alkyl betaine surfactant, an alkyl sulfobetaine surfactant and an alkylamidoalkylene hydroxysultaine surfactant, such as an alkylamidopropyl hydroxysultaine surfactant. For example, the foam composition may include a zwitterionic surfactant, which comprises one or more of a C₈₋₁₈-alkylamidopropyl hydroxysultaine surfactant, a C₈₋₁₈-alkylamidopropyl betaine surfactant a C₈₋₁₈-alkyl sulfobetaine surfactant and a C₈₋₁₈-alkyl betaine surfactant. Suitable examples of the alkylamidoalkylene hydroxysultaine surfactant include a C₈₋₁₈-alkylamidopropyl hydroxysultaine surfactant, such as a cocamidopropyl hydroxysultaine surfactant, that includes a laurylamidopropyl hydroxysultaine and a myristylamidopropyl hydroxysultaine. Suitable examples of the alkylamidoalkyl betaine surfactant include a C₈₋₁₈-alkylamidoalkyl betaine surfactant, such as a cocamidopropyl betaine, a tallowamidopropyl betaine, a laurylamidopropyl betaine, or a myristylamidopropyl betaine. In some embodiments, the zwitterionic surfactant includes a C₈₋₁₄-alkylamidopropyl hydroxysultaine, such as a cocamidopropyl hydroxysultaine. Suitable zwitterionic surfactants include, without limitation, betaines, sultaines, and amphoacetates. In an embodiment, the zwitterionic surfactant may include alkylamidoalkyl hydroxysultaine surfactants, alkylsulfobetaine surfactants and/or alkyl betaine surfactants. In an embodiment, the zwitterionic surfactant is selected from the group consisting of cocamidopropyl betaine, lauramidopropyl betaine, myristylamidopropyl betaine, cocamidopropyl hydroxysultaine, lauramidopropyl hydroxysultaine, sodium lauroamphoacetate, sodium cocoamphoacetate, disodium cocoamphodipropionate, and disodium lauroamphodipropionate. In some embodiments, the zwitterionic surfactant includes laurylamidopropyl hydroxysultaine and/or myristylamidopropyl hydroxysultaine. In embodiments that include the zwitterionic surfactant, the aqueous firefighting composition includes about 1 to 15 wt. % and often about 1 to 12 wt. % of the zwitterionic surfactant. In certain embodiments, the aqueous firefighting composition may include about 1 to 10 wt. %, or in some embodiments about 2 to 7 wt. %, of the zwitterionic surfactant.

Suitable amphoteric surfactants include, without limitation, sodium N-dodecyl-β-alanine, sodium N-lauryl-β-iminodipropionate, myristoamphoacetate, lauryl betaine, and lauryl sulfobetaine. In an embodiment, the amphoteric surfactant may include sodium-N-lauryl-β-iminodipropionate.

The amount of surfactant in the aqueous firefighting composition can vary depending on the type of surfactant(s) used. The aqueous firefighting composition may include about 2 to 10 wt. % and, in some instances about 4 to 8 wt. % of a nonionic surfactant, based on the total weight of the composition. In some embodiments, the composition may contain about 3-6 wt. % of the nonionic surfactant. The aqueous firefighting composition may include about 2 to 6 wt. % or about 2 to 5 wt. % of an anionic surfactant, based on the total weight of the composition. In some embodiments, the composition may include about 2.5 to 4 wt. % of an anionic surfactant. The aqueous firefighting composition may include about 3 to 6 wt. % of a zwitterionic surfactant, based on the total weight of the composition. In some embodiments, the composition may include about 3 to 5 wt. % of the zwitterionic surfactant. The aqueous firefighting composition may include about 0.5 to 5 wt. % of a amphoteric surfactant, based on the total weight of the composition. In some embodiments, the composition may include about 0.5 to 3 wt. % of the amphoteric surfactant.

The present aqueous firefighting compositions may include a water-miscible solvent, which may suitably include one or more of a glycol, a glycol ether, glycerol, and a water-soluble polyethylene glycol. Examples of suitable organic solvents include diethylene glycol n-butyl ether, dipropylene glycol n-propyl ether, hexylene glycol, ethylene glycol, propylene glycol, diethylene glycol, dipropylene glycol, tripropylene glycol, dipropylene glycol monobutyl ether, dipropylene glycol monomethyl ether, diethylene glycol monobutyl ether (“butyl carbitol”), ethylene glycol monobutyl ether, tripropylene glycol monomethyl ether, dipropylene glycol monoethyl ether, glycerol, and mixtures of two or more thereof. The organic solvent may include a mixture of glycerol (glycerine), an alkylene glycol, and a glycol ether, such as a glycol butyl ether. In some embodiments, the organic solvent includes an alkylene glycol ether, such as ethylene glycol monoalkyl ether, propylene glycol monoalkyl ether, dipropylene glycol monoalkyl ether (e.g., diethylene glycol monoalkyl ether (e.g., butyl carbitol). In some embodiments, the organic solvent includes an alkylene glycol, such as ethylene glycol, propylene glycol, dipropylene glycol and/or diethylene glycol. In some embodiments, the organic solvent includes a polyol, such as glycerine. The organic solvent may include a mixture of butyl carbitol, a glycol ether, such as ethylene glycol and/or propylene glycol, and glycerine. For example, the organic solvent can include glycerine, ethylene glycol, and butyl carbitol. In another suitable example, the organic solvent includes glycerine, propylene glycol, and butyl carbitol. In another suitable example, the organic solvent includes ethylene glycol and alkyl carbitol. In yet another suitable example, the organic solvent includes propylene glycol and butyl carbitol.

In some instances, the organic solvent present in the present compositions may include one or more glycol ethers having at least 8 carbon atoms and/or alkylene glycols having at least 5 carbon atoms (e.g., having about 5 to 12 carbon atoms). Examples of such alkylene glycols include 1,5-pentanediol, 1,6-hexanediol, hexylene glycol, 1,7-heptanediol, 1,8-octanediol, 1,9-nonanediol, 1,10-decanediol, and 1,12-dodecanediol. Examples of suitable glycol ethers include ethyleneglycol monophenyl ether, diethyleneglycol monobutyl ether (“butyl carbitol”), ethyleneglycol monohexyl ether, dipropyleneglycol monopropyl ether, and dipropylene glycol monobutyl ether. For example, the organic solvent may include one or more of 1,6-hexanediol, hexylene glycol, ethyleneglycol monophenyl ether, butyl carbitol, 1,12-dodecanediol, and dipropylene glycol monobutyl ether. For example, the organic solvent may include a combination of 1,6-hexanediol and dipropylene glycol monobutyl ether. In another suitable example, the organic solvent may include a combination of 1,6-hexanediol, ethyleneglycol, butyl carbitol, and dipropylene glycol monobutyl ether. In another suitable example, the organic solvent may include a combination of 1,6-hexanediol, dipropylene glycol monobutyl ether, and ethyleneglycol monophenyl ether. In another suitable example, the organic solvent may include a combination of 1,6-hexanediol, 1,12-dodecanediol, ethyleneglycol monophenyl ether, and dipropylene glycol monobutyl ether. In another suitable example, the organic solvent may include a combination of 1,12-dodecanediol, ethyleneglycol monophenyl ether, and dipropylene glycol monobutyl ether. In another suitable example, the organic solvent may include a combination of 1,6-hexanediol, 1,12-dodecanediol, and ethyleneglycol monophenyl ether.

The present composition may suitably include about 1 to 50 wt. % of the organic solvent. This may include about 1 to 25 wt. %, about 1 to 20 wt. %, about 2 to 15 wt. %, or about 5 to 10 wt. % of the organic solvent. In many embodiments, the aqueous firefighting foam composition includes an organic solvent including one or more of an alkylene glycol, glycerine, and a glycol ether. The alkylene glycol may include 1,6-hexanediol, 1,12-dodecanediol, propylene glycol and/or ethylene glycol. The glycol ether typically includes ethylene glycol monoalkyl ether, diethylene glycol monoalkyl ether, dipropylene glycol monoalkyl ether, triethylene glycol monoalkyl ether, ethyleneglycol monophenyl ether, and 1-butoxyethoxy-2-propanol. In some embodiments, the organic solvent may be a mixture of glycerine, alkylene glycol, and glycol ether. In some embodiments, the organic solvent may be a mixture of glycerine, propylene glycol, and alkyl carbitol. In some embodiments, the organic solvent may be a mixture of glycerine, ethylene glycol, and alkyl carbitol. In such embodiments, the organic may include the alkylene glycol and alkyl carbitol in a weight ratio of about 0.1:1 to 10:1 or about 0.2:1 to 5:1. In some embodiments, the organic solvent may be a mixture of glycerine, ethylene glycol, and butyl carbitol. In some embodiments, the composition may include about 1 to 15 wt. % and often about 1 to 10 wt. % alkylene glycol, such as ethylene glycol and/or propylene glycol, with about 1 to 15 wt. % and often about 1 to 10 wt. % of a glycol ether, such as butyl carbitol. In some instances, the composition may also include about 0.1 to 5 wt. % or about 0.1 to 2 wt. % glycerol.

In an embodiment, the water-miscible organic solvent may include alkylene glycol and alkyl carbitol in a weight ratio of about 0.1:1 to 5:1. In an embodiment, the organic solvent may include about 5 to 25 wt. % alkylene glycol and about 3 to 15 wt. % glycol ether. In an embodiment, the aqueous firefighting composition can include about 1 to 50 wt. % of the organic solvent. This may include about 1 to 25 wt. %, about 1 to 20 wt. %, about 2 to 15 wt. %, or about 5 to 10 wt. % of the organic solvent.

In some embodiments, the aqueous firefighting foam concentrate may also include a metallic salt, typically a metallic salt that includes a multi-valent cation. For example, suitable salts may include a cation selected from the group consisting of aluminum, calcium, copper, iron, magnesium, potassium, and calcium cations. The counteranion may suitably be a sulfate and/or phosphate anion. In one embodiment, the metallic salt may include a divalent salt, e.g., a magnesium salt such as magnesium sulfate, magnesium acetate, and magnesium nitrate. In an embodiment, the aqueous firefighting compositions may include, a divalent cation salt, such as magnesium sulfate and/or magnesium acetate. When included, a divalent salt may suitably be present as about 0.1 to 10 wt. %, about 0.3 to 5 wt. %, about 0.5 to 4 wt. % and in some instances, about 1 to 3 wt. % of the composition.

The aqueous firefighting compositions may further include a thickener, such as a polysaccharide thickener. The polysaccharide thickener may include a polysaccharide that is soluble in the aqueous firefighting foam concentrate and a second polysaccharide that is less soluble or insoluble in the aqueous firefighting foam concentrate. In some embodiments, the second polysaccharide may be insoluble (and dispersed) in the aqueous firefighting concentrate but may be soluble in water alone or in solutions where the concentrate has been diluted with a much larger volume of water. In other embodiments, the concentrate may only include one or more polysaccharides that are completely soluble in the concentrate. The foam concentrate typically includes about 0.1 to 5 wt. % of the polysaccharide thickener. This may include about 0.2 to 4 wt. %, about 0.3 to 3 wt. %, or about 0.5 to 3 wt. % of the polysaccharide thickener.

Suitable polysaccharide thickener include, without limitation, guar gum, diutan gum, xanthan gum, rhamsan gum, welan gum, gellan gum, mannan gum, locust bean gum, galactomannan gum, carrageenan, gum arabic, gum guaicum, neem gum, pistacia lentiscus, gum chatti, caranna, gum tragacanth, karaya gum, beta-glucan, chicle gum, kino gum, dammar gum, mastic gum, spruce gum, tara gum, acacia gum, cassia gum, fenugreek gum, ghatti gum, sulfated locust bean gum, sodium alginate, propylene glycol alginate, alginic acid, pectic acid, agar, pectin, starch, bacterial alginic acid, succinoglucan, cellulose, hydroxyethyl cellulose, hydroxypropyl cellulose, methylcellulose, carboxymethyl cellulose, heparin, phosphoric acid polysaccharide gums, dextran sulfate, dermantan sulfate, fucan sulfate, dextran and modified dextrans, neutral glucans, starch, and a mixture of two or more thereof. Suitable commercially available compounds are marketed under the trademarks Rhodopol, Kelco, Keltrol, Actigum, Cecal-gum, Calaxy, and Kalzan.

In some embodiments, the polysaccharide thickener may include one or more of xanthan gum, diutan gum, rhamsan gum, welan, gellan gum, guar gum, konjac gum, tarn gum, and methylcellulose. In some embodiments, it may advantageous to include a mixture of xanthan gum and one or more of diutan gum, rhamsan gum, welan, gellan gum, guar gum, konjac gum, tarn gum, and methylcellulose. In other embodiments, the firefighting composition may include a mixture of xanthan gum and one or more of diutan gum, rhamsan gum, welan gum, and gellan gum as the polysaccharide thickener. In other embodiments, the firefighting composition may advantageously include a mixture of xanthan gum and diutan gum and/or rhamsan gum. In other embodiments, the firefighting composition may advantageously include a mixture of xanthan gum and diutan gum. In other embodiments, the firefighting composition may advantageously include a mixture of xanthan gum and konjac gum.

Polysaccharide thickeners, which include a combination of xanthan gum and diutan gum, may be particularly suitable for use in the present firefighting compositions. For examples, the firefighting composition may include about 0.2 to 3 wt. %, about 0.3 to 2 wt. %, about 0.5 to 1.5 wt. % and even, about 0.5 to 1 wt. % xanthan gum. Such firefighting compositions may also include about 0.1 to 2 wt. %, about 0.2 to 1.5 wt. %, or even, about 0.2 to 1 wt. % diutan gum.

In other instances, polysaccharide thickeners, which include a combination of xanthan gum and succinoglycan, may be particularly suitable for use in the present foam concentrates. In other examples, the foam concentrate may include xanthan gum and about 0.5 to 5 wt. %, about 0.5 to 4 wt. % or even, about 1 to 3 wt. % succinoglycan.

In other instances, polysaccharide thickeners, which include a combination of xanthan gum and welan gum, may be particularly suitable for use in the present foam concentrates. In other examples, the foam concentrate may include xanthan gum and about 0.5 to 5 wt. %, about 0.5 to 4 wt. % or even, about 1 to 3 wt. % welan gum.

The present aqueous firefighting composition may include a sugar component. Saccharides suitable for use in the present aqueous fire-fighting foam concentrates are generally simple monosaccharide sugars and may include other carbohydrates, such as common sugar (sucrose/dextrose) derived from sugar cane or sugar beets. Sucrose is a disaccharide composed from the basic, simple sugar molecules glucose, and fructose. Mixtures where the majority of the sucrose has been broken down into its monosaccharide components, glucose and fructose (e.g., invert sugar), are quite suitable for use in the present concentrates. Sucrose is readily available in view of its world production from cane and sugar beet on the order of millions of tons per annum. Those skilled in the art will also be aware that other commercially available simple monosaccharides and related sugar alcohols can be utilized in the present foam concentrates. Examples of suitable monosaccharides for use in the present foam concentrates include one or more of glucose, fructose, mannose, xylose, and galactose. Examples of suitable sugar alcohols for use in the present foam concentrates include one or more of a four carbon sugar alcohol, such as erythritol, a five carbon alditol, such as xylitol, a six carbon alditol, such as mannitol and/or sorbitol, and other sugar alcohols, such as isomalt. The sugar alcohol may be one derived from a monosaccharide.

Suitable sugar components include, for example, monosaccharide sugars and/or sugar alcohols. Examples of suitable monosaccharides for use in the present foam compositions include one or more of glucose, fructose, mannose, xylose, and galactose. Examples of suitable sugar alcohols for use in the present foam compositions include one or more of a four carbon sugar alcohol, such as erythritol, a five carbon alditol, such as xylitol, a six carbon alditol, such as mannitol and/or sorbitol, and other sugar alcohols, such as isomalt. Sugars and/or sugar alcohols suitable for use in the present aqueous fire-fighting foam compositions are generally simple monosaccharide sugars or related sugar alcohols, but may include small amounts of other carbohydrates, such as common sugar (sucrose/dextrose) derived from sugar cane or sugar beets. Sucrose is a disaccharide composed from the basic, simple sugar molecules glucose and fructose. Mixtures where the majority of the sucrose has been broken down into its monosaccharide components, glucose and fructose (e.g., invert sugar), are quite suitable for use in the present compositions. The sugar component may contain at least about 40 wt. %, or preferably at least 50 wt. % monosaccharide sugars and/or sugar alcohols. Often, the sugar component suitably contains at least about 40 wt. %, or more preferably at least about 50 wt. % monosaccharide sugars, such as glucose and/or fructose. The sugar component typically contains a total of no more than about 10 wt. % and, often no more than about 5 wt. % disaccharide sugars and oligosaccharides (as a percentage of the total weight of the sugar component). In an illustrative embodiment, the sugar component includes at least about 50 wt. % of a sugar alcohol, a monosaccharide sugar or combinations thereof.

In some embodiments, the present aqueous fire-fighting foam concentrates may include a sugar component comprising at least about 50 wt. % of one or more monosaccharide sugars and/or sugar alcohols. Suitable examples include a sugar component containing one or more of glucose, fructose, mannose, xylose, sorbitol, xylitol, and mannitol. The foam concentrate may include about 5 to 25 wt. %, or about 10 to 20 wt. %, of the sugar component. In some instances, the foam concentrate may include as much as about 45 wt. % or even 50 wt. % of the sugar component. In some embodiments, the sugar component comprises at least about 75 wt. %, at least about 80 wt. %, or even at least about 90 wt. % monosaccharide sugar and/or sugar alcohol. For example, the sugar component may comprise at least about 50 wt. %, at least about 75 wt. %, at least about 80 wt. %, or even at least about 90 wt. % of one or more of glucose, fructose, mannose, xylitol, sorbitol and mannitol. In some embodiments, the foam concentrate may include a sugar component, which comprises at least about 50 wt. % of one or more sugar alcohols, such as xylitol, sorbitol and mannitol. Advantageously, the sugar component may include at least about 50 wt. %, at least about 75 wt. %, at least about 80 wt. %, or even at least about 90 wt. % of one or more of glucose, fructose and sorbitol. For example, the sugar component may include at least about 50 wt. %, or at least about 75 wt. % glucose and/or fructose.

The aqueous firefighting compositions may further include one or more additives, such as chelating agents, electrolytes, foam stabilizers, foaming agent, diluents, film formers, antimicrobials, preservatives, corrosion inhibitors, and pH adjusting agents. Such materials are well known to those skilled in the art. In an embodiment, the aqueous firefighting compositions may further include preservative, a corrosion inhibitor, and a pH-adjusting agent.

In some embodiments, the aqueous firefighting foam composition includes one or more chelators or sequestering buffers. Illustrative and non-limiting chelators and sequestering buffers include agents that sequester and chelate metal ions, including polyamminopolycarboxylic acids, ethylenediaminetetraacetic acid, citric acid, tartaric acid, nitrilotriacetic acid, hydroxyethylethylenediaminetriacetic acid, and salts thereof. Illustrative buffers include Sorensen's phosphate or Mellvaine's citrate buffers.

In some embodiments, the aqueous firefighting foam composition includes one or more corrosion inhibitors. Suitable corrosion inhibitors, include, without limitation, ortho-phenylphenol, tolyltriazole, and phosphate ester acids. In an embodiment, the corrosion inhibitor includes tolyltriazole. The corrosion inhibitor, when present, may be included in an amount of from about 0.01 to about 5 wt. %, based on the total weight of the composition.

In some embodiments, the aqueous firefighting compositions may further include a preservative ingredient, such as one or more antimicrobial additives and/or biocidal additives. These components are included to prevent the biological decomposition of natural product based polymers that are incorporated as polymeric film formers (e.g., a polysaccharide gum). Examples include Kathon CG/ICP (Rohm & Haas Company), Givgard G-4 40 (Givaudan, Inc.), Dowicil 75 and Dowicide A (Dow Chemical Company). In some instances, the biocidal agent in the present composition may include a phenol-based biocide, such as Dowicide A (sodium o-phenylphenate). Such more preservative ingredients, when present, may be included in an amount of from about 0.01 to about 5 wt. %, based on the total weight of the composition.

In many instances, the present aqueous firefighting foam composition may include an alkanolamine, which can act as a pH adjusting agent and/or buffer. Suitable alkanolamines comprise monoethanolamine, diethanolamine, diisopropanolamine, and/or triethanolamine. The present compositions may include triethanolamine. The triethanolamine may be present in only a relatively small amount, e.g., about 0.1 to 0.3 wt. % when included primarily as a pH adjusting agent. In other instances, the alkanolamine may be present in a higher amount, whether introduced per se as an ingredient and/or in the form of a cation as part of one of the surfactants present in the composition. In such instances, an alkanolamine such as triethanolamine, may suitably be present as about 0.1 to 5 wt. %, about 0.3 to 5 wt. %, about 0.5 to 3 wt. % and in some instances, about 0.5 to 2 wt. % of the composition.

As discussed above, the aqueous firefighting composition includes water. In some embodiments, the water is water from a municipal water source (e.g., tap water). In some embodiments, the water is a purified water, such as purified water that meets the standards set forth in the United States Pharmacopeia, which is incorporated by reference herein in relevant part. In some embodiments, the aqueous firefighting composition includes at least about 30 wt. % water, at least about 40 wt. % water, or at least about 50 wt. % water. In some embodiments, the aqueous firefighting foam composition includes greater than about 60 wt. % water. In some embodiments, the aqueous firefighting composition may be produced using a source of water that has a total concentration of fluorine atoms on a weight percentage basis of no more than about 1 ppm F.

### Illustrative Embodiments

Reference is made to a number of illustrative embodiments of the subject matter described herein. The following embodiments describe illustrative embodiments that may include various features, characteristics, and advantages of the subject matter as presently described. Accordingly, the following embodiments should not be considered as being comprehensive of all of the possible embodiments or otherwise limit the scope of the methods, materials, and compositions described herein. One illustrative embodiment provides aqueous firefighting compositions which include (a) a cationic polymer comprising polymerized units derived from a mixture comprising (i) a water-soluble (meth)acrylamide monomer, (ii) a cationic monomer comprising a quaternary ammonium salt, and (iii) optionally, a silicone-containing monomer, and (iv) optionally, an anionic monomer containing at least one carboxylate and/or sulfonate group; (b) a surfactant component comprising anionic surfactant and nonionic surfactant; (c) water-miscible organic solvent comprising an alkylene glycol and/or an alkylene glycol ether; and (d) divalent cation salt; the composition being substantially free of fluorinated additives.

Another illustrative embodiment provides an aqueous firefighting composition including (a) a cationic copolymer comprising polymerized units derived from a mixture that includes (i) a water-soluble (meth)acrylamide monomer, (ii) an N-vinylformamide monomer, (iii) a cationic monomer comprising a quaternary ammonium salt, and (iv) a silicone-containing monomer, and (v) optionally, an anionic monomer containing at least one carboxylate and/or sulfonate group; (b) a surfactant component comprising anionic surfactant and nonionic surfactant; (c) water-miscible organic solvent comprising an alkylene glycol and/or an alkylene glycol ether; and (d) divalent cation salt; the composition being substantially free of fluorinated additives.

Another illustrative embodiment provides aqueous firefighting compositions which include (a) a cationic polymer comprising polymerized units derived from a mixture comprising (i) a water-soluble (meth)acrylamide monomer, (ii) a cationic monomer comprising a quaternary ammonium salt, and (iii) optionally, a silicone-containing monomer, and (iv) optionally, an anionic monomer containing at least one carboxylate and/or sulfonate group; (b) a surfactant component comprising anionic surfactant and zwitterionic surfactant; and (c) a sugar component; the composition being substantially free of fluorinated additives.

Another illustrative embodiment provides an aqueous firefighting composition including (a) a cationic copolymer comprising polymerized units derived from a mixture that includes (i) a water-soluble (meth)acrylamide monomer, (ii) an N-vinylformamide monomer, (iii) a cationic monomer comprising a quaternary ammonium salt, and (iv) a silicone-containing monomer, and (v) optionally, an anionic monomer containing at least one carboxylate and/or sulfonate group; (b) a surfactant component comprising anionic surfactant and zwitterionic surfactant; and (c) a sugar component; the composition being substantially free of fluorinated additives.

An illustrative embodiment provides aqueous firefighting compositions which include (a) a cationic polymer comprising polymerized units derived from a mixture comprising (i) a water-soluble (meth)acrylamide monomer, and (ii) a cationic monomer comprising a quaternary ammonium salt. The mole ratio of the (i) a water-soluble (meth)acrylamide monomer to (ii) a cationic monomer comprising a quaternary ammonium salt can range from about 1.0:0.05 to about 0.05:1.0, including about 1.0:0.1, about 1.0:0.2, about 1.0:0.4, about 1.0:0.4, about 1.0:0.7, about 1.0:1.0 or about 0.2:1.0, and ratios in between and including the two values.

An illustrative embodiment provides aqueous firefighting compositions which include (a) a cationic polymer comprising polymerized units derived from a mixture comprising (i) a water-soluble (meth)acrylamide monomer, (ii) an N-vinylformamide monomer, (iii) a cationic monomer comprising a quaternary ammonium salt, and (iv) a silicone-containing monomer. The mole ratio of the (i) a water-soluble (meth)acrylamide monomer to (ii) an N-vinylformamide monomer to (iii) a cationic monomer comprising a quaternary ammonium salt to (iv) a silicone-containing monomer may be from about 1:0.05-3.5:0.05-0.50:0.05-0.15, including about 1.0:1.09:0.18:0.09, including about 1.0:1.5:0.2:0.15, including about 1.0:2.0:0.3:0.15, including about 1.0:2.5:0.4:0.15, including about 1.0:3.5:0.5:0.15, including about 1.0:1.0:0.1:0.1, including about 1.0:0.5:0.05:0.05, including about 1.0:0.3:0.05:0.05, including about 1.0:0.1:0.05:0.05, or about 1.0:0.05:0.05:0.05, and ratios in between and including these values.

Yet another illustrative embodiment provides aqueous firefighting compositions which include (a) a cationic polymer comprising polymerized units derived from a mixture comprising (i) a water-soluble (meth)acrylamide monomer, (ii) a cationic monomer comprising a quaternary ammonium salt, and (iii) optionally, a silicone-containing monomer, and (iv) optionally, an anionic monomer containing at least one carboxylate and/or sulfonate group; (b) a surfactant component; and (c) a polysaccharide thickener; the composition being substantially free of fluorinated additives.

Yet another illustrative embodiment provides aqueous firefighting compositions which include (a) a cationic polymer comprising polymerized units derived from a mixture comprising (i) a water-soluble (meth)acrylamide monomer, (ii) an N-vinylformamide monomer, (iii) a cationic monomer comprising a quaternary ammonium salt, and (iv) a silicone-containing monomer, and (v) optionally, an anionic monomer containing at least one carboxylate and/or sulfonate group; (b) a surfactant component; and (c) a polysaccharide thickener; the composition being substantially free of fluorinated additives. In one or more of the illustrative embodiments described above, the cationic polymer may be derived from polymerizing (i) N,N-dimethylacrylamide; and (ii) (3-methacrylamidopropyl) trimethyl ammonium chloride. The mole ratio of (i) N,N-dimethylacrylamide and (ii) (3-methacrylamidopropyl)trimethyl ammonium chloride is from about 1.0 to about 0.05-1.0.

Another illustrative embodiment provides aqueous firefighting compositions which include (a) a cationic polymer comprising polymerized units derived from a mixture comprising (i) N,N-dimethylacrylamide and/or N-isopropylacrylamide, (ii) (3-acrylamidopropyl)trimethyl ammonium chloride and/or (2-acrylamidoethyl)trimethyl ammonium chloride, and (iii) optionally 3-[tris(trimethylsiloxy)silyl]propyl methacrylate. The mole ratio of the monomers (i) N,N-dimethylacrylamide and/or N-isopropylacrylamide, (ii) (3-acrylamidopropyl)trimethyl ammonium chloride and/or (2-acrylamidoethyl)trimethyl ammonium chloride, and (iii) optionally 3-[tris(trimethylsiloxy)silyl]propyl methacrylate may range from about 1:0.05-1.0:0.005-0.15, including about 1:0.36:0.04, about 1:0.18:0.09, about 1:0.18:0.09, about 1:0.36:0.02, about 1:0.18:0.12, about 1:0.38:0.01, about 1:0.30:0.09, about 1:0.5:0.09 and about 1:0.36:0.10, and ranges in between and including these values.

Another illustrative embodiment provides aqueous firefighting compositions which include (a) a cationic polymer comprising polymerized units derived from a mixture comprising (i) N,N-dimethylacrylamide, (ii) N-vinylformamide, (iii) (3-methacrylamidopropyl)trimethyl ammonium chloride, and (iv) optionally 3-[tris(trimethylsiloxy)silyl]propyl methacrylate. The mole ratio of the monomers (i) N,N-dimethylacrylamide, (ii) N-vinylformamide, (iii) (3-methacrylamidopropyl)trimethyl ammonium chloride, and (iv) optionally 3-[tris(trimethylsiloxy)silyl]propyl methacrylate may range from about 1:0.05-3.5:0.05-0.50:0.05-0.15, including about 1.0:1.09:0.18:0.09, including about 1.0:1.5:0.2:0.15, including about 1.0:2.0:0.3:0.15, including about 1.0:2.5:0.4:0.15, including about 1.0:3.5:0.5:0.15, including about 1.0:1.0:0.1:0.1, including about 1.0:0.5:0.05:0.05, including about 1.0:0.3:0.05:0.05, including about 1.0:0.1:0.05:0.05, or about 1.0:0.05:0.05:0.05, and ratios in between and including these values.

Yet another illustrative embodiment provides aqueous firefighting compositions which include (a) a cationic polymer comprising polymerized units derived from a mixture comprising (i) N,N-dimethylacrylamide and/or N-isopropylacrylamide, (ii) (3-methacrylamidopropyl) trimethyl ammonium chloride and/or (2-methacrylamidoethyl)trimethyl ammonium chloride, and (iii) optionally 3-[tris(trimethylsiloxy)silyl]propyl methacrylate.

Another illustrative embodiment provides aqueous firefighting compositions which include (a) a cationic polymer comprising polymerized units derived from monomers comprising (i) N,N-dimethylacrylamide and acrylamide, (ii) (3-acrylamidopropyl)trimethyl ammonium chloride and/or (2-acrylamidoethyl)trimethyl ammonium chloride, and (iii) optionally 3-[tris(trimethylsiloxy)silyl]propyl methacrylate.

Another illustrative embodiment provides aqueous firefighting compositions which include (a) a cationic polymer comprising polymerized units derived from monomers comprising (i) N,N-dimethylacrylamide, (ii) N-vinylformamide, (iii) (3-methacrylamidopropyl)trimethyl ammonium chloride, and (iv) optionally 3-[tris(trimethylsiloxy)silyl]propyl methacrylate. Yet another illustrative embodiment provides aqueous firefighting compositions which include a cationic polymer comprising polymerizing monomers comprising (i) N,N-dimethylacrylamide; (ii) (3-acrylamidopropyl)trimethyl ammonium chloride; (iii) 3-[tris(trimethylsiloxy)silyl]propyl methacrylate; and (iv) acrylamide. The mole ratio of the monomers (i) N,N-dimethylacrylamide; (ii) (3-acrylamidopropyl)trimethyl ammonium chloride; (iii) 3-[tris(trimethylsiloxy)silyl]propyl methacrylate; and (iv) acrylamide may range from about 1.0:0.01-0.5:0.02-0.15:0.5-2.5, including about 1:0.18:0.09:0.09, about 1:0.18:0.09:0.18, about 1:0.18:0.09:0.54, about 1:0.18:0.09:1.09, about 1:0.18:0.09:1.09, about 1:0.18:0.09:1.09, about 1:0.18:0.09:2.2, about 1:0.18:0.09:2.0, about 1:0.18:0.09:2.20 or about 1:0.18:0.09:1.09, and ranges in between and including these values.

Another illustrative embodiment provides aqueous firefighting compositions which include (a) a cationic polymer comprising polymerized units derived from monomers comprising (i) N,N-dimethylacrylamide and acrylamide, (ii) (3-acrylamidopropyl) trimethyl ammonium chloride and/or (2-acrylamidoethyl)trimethyl ammonium chloride, and (iii) optionally 3-[tris(trimethylsiloxy)silyl]propyl methacrylate.

The present technology provides firefighting compositions of the synthetic type which meet and exceed UL listing requirements for use on Class B fires as listed in UL162 that may have “zero” fluorine content. Further, these products may be used at 3% concentrate level. No fluorosurfactants or fluorinated polymers are required to meet the UL162 standard but may be used to improve extinguishing speed and burnback times, if desired. The compositions for use as fire extinguishing concentrates can meet or exceed fluoroprotein (FP) and AFFF performance criteria on Class B, UL162 non-polar (water insoluble) liquid fires, but without the need of fluorochemical surfactants or polymers, as required in the prior art. These compositions include synthetic liquid concentrates stabilized with high molecular weight acidic polymers (HMWAP) and coordinating salt(s), which extinguish non-polar Class B fires. No fluorosurfactants or fluorinated polymers are required to meet the UL162 standard, but may be used to improve extinguishment speed and burnback times, if desired. In an embodiment, the aqueous firefighting composition meets UL162, Class B performance criteria for at least one of AFFF agents and fluoroprotein (FP) agents without requiring any fluorinated additive.

### Method of Producing a Firefighting Foam

The firefighting compositions described herein may be mixed with a diluent to form firefighting foam precursor solution, i.e., a use strength composition. The firefighting foam precursor solution may be aerated (e.g., using a nozzle) to produce a firefighting foam including the firefighting foam concentrate and the diluent. Typically, the concentrate is mixed into a flowing stream of the diluent, e.g., the concentrate is introduced through the use of an eductor into a stream of the diluent flowing through a hose or pipe. Illustrative diluents may include water, such as fresh water, brackish water, sea water, and combinations thereof. In some embodiments, the firefighting compositions described above may be 1 vol. %, 3 vol. %, or 5 vol. % concentrate solutions, meaning that the firefighting compositions are mixed with 99 vol. %, 97 vol. %, or 95 vol. % diluent, respectively, to form the firefighting precursor solution.

In some instances, it has been found that the order of addition of ingredients with appropriate agitation in producing the present concentrates may impact the actual firefighting performance as seen in the UL and EN fire tests. It may be suitable to begin by mixing all or a portion of a water-miscible solvent component with a substantial amount of water and subsequently preparing a solution or slurry of the polysaccharide thickener in the resulting aqueous solution prior to blending in the remaining components of the foam concentrate. It was found that first preparing a suspension by combining and mixing water-miscible solvent with gum may facilitate later dissolution and/or dispersal of biogums/biopolymers (e.g., xanthan gum) in water. This can allow the gums to properly hydrate without encapsulating (clumping) upon the addition of the surfactant(s), other optional additives, and remaining amounts of water. Surfactants and other optional additives can then be added and the resulting mixture may finally be diluted further with water to decrease the viscosity of the preparation, if desired.

Firefighting foams that were prepared not following this order of component addition may result in polysaccharide biogums that are encapsulated, but not fully hydrated, which can result in the production of foams that exhibit less than satisfactory for fire suppression performance. Thus, in some embodiments, the initial formation of an aqueous solution containing water-miscible solvent can be important in process order and can be used to dissolve/disperse polysaccharide thickener(s) into the foam concentrate before addition of any other ingredients, such as surfactant(s) and/or other additives.

Another illustrative embodiment provides a method of forming a firefighting foam including diluting the composition of any of the aqueous firefighting foam compositions previously disclosed herein with an aqueous diluting agent to provide a foam precursor solution, and aerating the foam precursor solution to provide the firefighting foam. The aqueous diluting agent may include one or more of municipal water, brackish water and salt water.

### Method of Fighting a Fire

The firefighting compositions described herein may be used to fight one or more of class A fires, class B fires, class C fires, class D fires and class K fires. In an embodiment, the firefighting compositions described herein are used to fight one or more of class A fires, class B fires, and class D fires. In an embodiment, the firefighting compositions described herein are used to fight class B fires. The firefighting compositions described herein may be used to fight a fire and/or to suppress flammable vapors by forming a foam comprising the aqueous firefighting composition and applying the foam directly or indirectly onto the fire.

The firefighting compositions described herein may be used to fight a fire and/or to suppress flammable vapors by mixing the firefighting foam compositions with a diluent, aerating the resulting firefighting foam precursor solution to form a firefighting foam, and administering the firefighting foam to a fire or applying the firefighting foam to the surface of a volatile flammable liquid (e.g., gasoline or other flammable hydrocarbon or a flammable polar solvent).

Another illustrative embodiment provides a method of fighting a fire, including forming a foam from a composition that includes at least one of the aqueous firefighting foam compositions previously disclosed herein, and applying the foam directly or indirectly onto the fire. Such a method may be employed to fight a class A or class B fire.

Tables A-E provide illustrative examples of firefighting compositions that are suitable under the present disclosure. The compositions are designed to be combined with an aqueous diluent, aerated, and administered to as a firefighting foam to fight and/or suppress a fire.

TABLE A
1 × 1 AR-AFFF

| Component | Amount (wt. %) |
|---|---|
| Biocide | 0 − 0.2 |
| Corrosion Inhibitor | 0 − 0.2 |
| Decyl Sulfate Anionic Surfactant | 1 − 5 |
| Polyquat/siloxane polymer | 1 − 10 |
| Lauryl Dipropionate surfactant | 1 − 5 |
| Polysaccharide Gum {e.g., xanthan, diutan, | 0 − 3 |
| welan and/or rhamsan gum} | |
| Glycol Ether Solvent {e.g., Butyl carbitol } | 5 − 10 |
| Polyol Solvent {e.g., Ethylene glycol} | 15 − 30 |
| Alkanolamine | 0 − 3 |
| Water | Balance |

TABLE B
3 × 3 AR-AFFF

| Component | Amount (wt. %) |
|---|---|
| Biocide | 0 − 0.2 |
| Corrosion Inhibitor | 0 − 0.2 |
| Decyl Sulfate Anionic Surfactant | 1 − 5 |
| Polyquat/siloxane polymer | 1 − 10 |
| Alkyl sulfo-betaine surfactant | 1 − 5 |
| Alkyl polysaccharide surfactant | 2 − 6 |
| Polysaccharide Gum {e.g., xanthan, diutan, | 0.4 − 5 |
| welan and/or rhamsan gum} | |
| Glycol Ether Solvent {e.g., Butyl carbitol } | 5 − 10 |
| Polyol Solvent {e.g., Ethylene glycol} | 15 − 30 |
| Magnesium sulfate | 0.5 − 3 |
| Alkanolamine | 0 − 3 |
| Water | Balance |

TABLE C
AR-AFFF

| Component | Amount (wt. %) |
|---|---|
| Biocide | 0 − 0.2 |
| Corrosion Inhibitor | 0 − 0.2 |
| Alkyl Sulfate Anionic Surfactant | 2 − 20 |
| Polyquat/siloxane polymer | 1 − 10 |
| Alkyl sulfo-betaine surfactant | 1 − 10 |
| Alkyl polysaccharide surfactant | 2 − 6 |
| Fatty alcohol-type surfactant | 0 − 3 |
| Polysaccharide Gum {e.g., xanthan, diutan, | 0.4 − 3 |
| welan and/or rhamsan gum} | |
| Monosaccharide sugar | 10 − 25 |
| Glycol Ether Solvent {e.g., Butyl carbitol } | 0 − 15 |
| Polyol Solvent {e.g., Ethylene glycol} | 0 − 10 |
| Magnesium sulfate | 0.5 − 3 |
| Alkanolamine | 0 − 10 |
| Water | Balance |

TABLE D
AR-AFFF

| Ingredient | Amount (wt. %) |
|---|---|
| Biocide | 0 − 0.2 |
| Corrosion Inhibitor | 0 − 0.2 |
| Polyquat/siloxane polymer | 1 − 10 |
| Hydroxysultaine Zwitterionic Surfactant | 1 − 5 |
| Alkyl Sulfate Anionic Surfactant | 5 − 15 |
| Polysaccharide Gum | 0.2 − 3 |
| Glycol Ether Solvent | 2 − 15 |
| Polyol Solvent | 2 − 10 |
| Monosaccharide sugar(s) and/or | 10 − 25 |
| sugar alcohol(s) | |
| Alkanolamine | 0.1 − 5 |
| Water | Balance |

TABLE E
3 × 3 AR-AFFF (wt. %)

| Component | Amount (wt. %) |
|---|---|
| Biocide | 0 − 0.2 |
| Corrosion Inhibitor | 0 − 0.2 |
| Polyquat polymer | 1 − 10 |
| Alkyl Sulfate Anionic Surfactant | 2 − 8 |
| Alkyl polysaccharide surfactant | 1 − 10 |
| Glycol Ether Solvent {e.g., Butyl carbitol } | 2 − 15 |
| Polyol Solvent {e.g., Ethylene glycol } | 5 − 25 |
| Magnesium sulfate | 0.5 − 3 |
| Alkanolamine | 0 − 3 |
| Water | Balance |

### EXAMPLES

The following examples more specifically illustrate formulations for preparing aqueous firefighting compositions according to various embodiments described herein. These examples should in no way be construed as limiting the scope of the present technology.

### Examples

Tables 1 and 2 below show the compositions of a number of illustrative formulations of the present aqueous firefighting foam concentrate. The amounts shown in the Table 1 represent the weight percentage of the particular active component based on the total weight of the composition. Table 1 shows the composition of the base formulation that was used to prepare a number of different examples of the present concentrate. The base formulation includes a biocide; a corrosion inhibitor, such as tolyltriazole; anionic surfactant(s), such as the sodium salt of octyl sulfate; a nonionic surfactant, such as a C_{8/10} alkyl polyglucoside; a water-miscible organic solvent, such as ethylene glycol and/or butyl carbitol; a divalent metal salt, such as magnesium sulfate; and water together with one of the quaternary group substituted copolymers described herein. Illustrative examples of specific quaternary group substituted copolymers are detailed in Table 2. Unless specifically noted, the quaternary group substituted copolymers component was included at a level of 5 wt. % of the concentrate. The concentrates were then diluted 97:3 with tap water to provide foam precursor solutions, which were used for measuring various properties of the examples. Viscosity measurements, where reported, were made using the undiluted concentrate. The measured properties of various examples are shown in Tables 2 and 3. The following monomers were used to prepare the illustrative copolymers listed in Tables 2 and 3:
DMAA—N,N′-dimethyl acrylamide
A174—3-trimethoxysilylpropyl methacrylate
TRIS—Methylacryloxypropyltris(trimethylsiloxy) silane
MethylTRIS—3-[Tris(trimethylsiloxy)silyl]propyl N-methyl methacrylamide
DADAC—diallyldimethyl ammonium chloride
AMPS—2-Acrylamido-2-methyl-1-propanesulfonic acid
APTAC—(3-Acrylamidopropyl)trimethyl ammonium chloride
AETAC—(3-Acrylamidoethyl)trimethyl ammonium chloride
MAPTAC—(3-Methacrylamidopropyl)trimethyl ammonium chloride
MAETAC—(3-Methacrylamidoethyl)trimethyl ammonium chloride
NIPAM—N-isopropyl acrylamide

TABLE 1
Base Formula

| Component | Base Formula |
|---|---|
| Na octyl sulfate | 4 |
| Simusol SL8 (C8/10 APG) | 7.5 |
| Quat copolymer | ~5 |
| Butyl carbitol | ~9 |
| Ethylene glycol | ~20 |
| Mg Sulfate | 1.0 |
| Preservative | {0.1} |
| Tolyltriazole | 0.06 |
| Lauryl dipropionate | 1.5 |
| Water | ~52 |

TABLE 2
Illustrative Quat Polymers

| | | | 50% Drain | Viscosity |
|---|---|---|---|---|
| | | Foam | Time (DT) | (of Conc. in |
| Monomers | Monomer Ratio | Expansion | (min:sec) | cPs) |
| 3% IMO Base w/ | | 7.5 | 11:15 | 11 |
| Fluorosurfactants | | | | |
| 3% IMO Base w/ | | 6 | 14:00 | 15 |
| polyacrylamide | | | | |
| DMAA:APTAC | 1.0:0.1 | 5.8 | 08:46 | |
| DMAA:APTAC | 1:0.2 | 5.8 | 09:47 | 64 |
| DMAA:APTAC | 1:0.3 | 5.8 | 10:27 | 150 |
| DMAA:APTAC | 1:0.4 | 6.2 | 11:57 | 150 |
| DMAA:APTAC | 1:0.75 | 6 | 09:49 | |
| DMAA:APTAC | 1:1.0 | 6.3 | 09:00 | |
| DMAA:APTAC | 0.2:1.0 | 5.7 | 09:05 | 38 |
| DMAA:AMPS:APTAC | 1:0.1:0.1 | 6.3 | 08:09 | 62 |
| DMAA:APTAC:TRIS | 1:0.18:0.02 | 6.3 | 09:16 | 146 |
| DMAA:APTAC:TRIS | 1:0.36:0.04 | 6.4 | 09:05 | 146 |
| DMAA:APTAC:TRIS | 1:0.18:0.09 | 6 | 10:15 | 146 |
| DMAA:APTAC:TRIS | 1:0.18:0.09 | 6.3 | 11:09 | 146 |
| DMAA:APTAC:TRIS | 1:0.36:0.02 | 6.6 | 09:09 | |
| DMAA:APTAC:TRIS | 1:0.18:0.12 | 6 | 14:36 | |
| DMAA:APTAC:TRIS | 1:0.38:0.01 | 6.4 | 09:39 | |
| DMAA:APTAC:TRIS | 1:0.30:0.09 | 6.4 | 08:14 | |
| DMAA:APTAC:TRIS | 1:0.5:0.09 | 5.9 | 09:20 | |
| DMAA:APTAC:TRIS | 1:0.36:0.10 | 6.1 | 07:59 | |
| DMAA:APTAC:MethylTRIS | 1:0.18:0.02 | 5.8 | 09:07 | 146 |
| DMAA:MAPTAC:TRIS | 1:0.18:0.02 | 6.5 | 08:41 | 146 |
| DMAA:APTAC:Lauryl | 1:0.18:0.02 | 5.8 | 09:43 | 235 |
| methacrylate | | | | |
| DMAA:TBAM:APTAC | 0.95:0.05:0.2 | 5.8 | 09:59 | 86 |
| DMAA:MAPTAC | 1:0.1 | 6.2 | 09:31 | 98 |
| DMAA:MAPTAC | 1:0.2 | 6 | 09:57 | 98 |
| DMAA:MAPTAC | 1:0.4 | 6 | 09:31 | 98 |
| DMAA:MAETAC | 1:0.2 | 6 | 10:10 | 127 |
| DMAA:AETAC | 1:0.2 | 5.9 | 10:37 | 76 |
| DMAA:DADAC | 1:0.2 | 5.5 | 6:35 | 203 |
| DMAA:APTAC:TRIS:Acrylamide | 1:0.18:0.09:0.09 | 6.2 | 11:09 | |
| DMAA:APTAC:TRIS:Acrylamide | 1:0.18:0.09:0.18 | 6.2 | 10:21 | |
| DMAA:APTAC:TRIS:Acrylamide | 1:0.18:0.09:0.54 | 6.4 | 10:13 | |
| DMAA:APTAC:TRIS:Acrylamide | 1:0.18:0.09:1.09 | 6.8 | 10:47 | |
| DMAA:APTAC:TRIS:Acrylamide | 1:0.18:0.09:1.09 | 6.5 | 11:07 | |
| (diluted to 2.7%) | | | | |
| DMAA:APTAC:TRIS:Acrylamide | 1:0.18:0.09:2.2 | 6 | 13:11 | |
| DMAA:APTAC:TRIS:Acrylamide | 1:0.18:0.09:2.0 | 6.2 | 09:13 | |
| DMAA:APTAC:TRIS:Acrylamide | 1:0.18:0.09:2.20 | | | |
| (diluted to 2.7% in conc.) | | | | |
| DMAA:APTAC:TRIS: | 1:0.18:0.09:0.18 | 5.8 | 12:30 | |
| Acrylic Acid 13% | | | | |
| DMAA:APTAC:TRIS: | 1:0.18:0.09:0.18 | 6.5 | 07:34 | |
| Acrylic Acid (2.7% in conc.) | | | | |
| DMAA:APTAC:TRIS: | 1:0.18:0.12:0.54 | 6.3 | 12:43 | |
| Acrylamide | | | | |
| DMAA:APTAC:TRIS:Methyl | 1:0.18:0.09:0.09 | 6.2 | 11:15 | |
| Acrylate | | | | |
| DMAA:APTAC:TRIS:Methyl | 1:0.18:0.09:0.045 | 6 | 10:47 | |
| Acrylate | | | | |
| DMAA:APTAC:TRIS:Na- | 1:0.18:0.09:0.4 | 6.3 | 8:50 | |
| Acrylate (9.5% in conc.) | | | | |
| DMAA:APTAC:TRIS:Na- | 1:0.18:0.09:0.4 | 6.9 | 8:52 | |
| Acrylate (2% in conc.) | | | | |
| DMAA:APTAC:TRIS:Na- | 1:0.18:0.09:0.18 | 5.7 | 08:08 | |
| AMPS | | | | |
| DMAA:APTAC:TRIS:Na- | 1:0.18:0.09:0.18 | 5.7 | 08:08 | |
| AMPS | | | | |
| DMAA:APTAC:TRIS: | 1:0.18:0.09:0.07 | 6.5 | 9:42 | |
| Glycerol | | | | |
| DMAA:APTAC:TRIS:N- | 1:0.18:0.09:1.09 | 6.8 | 10:47 | |
| vinyl formamide | | | | |
| DMAA:APTAC:A174: | 1:0.18:0.09:1.09 | 6.2 | 12:00 | |
| Acrylamide | | | | |
| DMAA:APTAC:TRIS:AMPs:Acrylamide | 1:0.18:0.09:0.002:1.09 | 6.7 | 10:14 | |
| DMAA:APTAC:TRIS:Glycerol:Acrylamide | 1:0.18:0.09:0.06:1.09 | 6.7 | 10:20 | |
| DMAA:APTAC:Silmer Di- | 1:0.18:0.09:1.09 | 6 | 10:15 | |
| 10:Acrylamide | | | | |
| DMAA:APTAC:Silmer Di- | 1:0.18:0.09:1.09 | 6.3 | 10:50 | |
| 1508:Acrylamide | | | | |

TABLE 3
Illustrative Quat Polymers

| | | | | Burn |
|---|---|---|---|---|
| | Monomer | Static Stability | Extinguishment | Back |
| Monomers | Ratio | (min) Heptane | (sec) | (min:sec) |
| 3% IMO Base w/ | | 180 | | 4:02 |
| Fluorosurfactants | | | | |
| 3% IMO Base w/ | | 34 | 31 | 3:22 |
| polyacrylamide | | | | |
| DMAA:APTAC | 1.0:0.1 | 42 | 38 | 2:56 |
| DMAA:APTAC | 1:0.2 | 69 | 33 | 4:29 |
| DMAA:APTAC | 1:0.33 | 55 | 44 | 4:36 |
| DMAA:APTAC | 1:0.4 | 90 | 37 | 8:36 |
| DMAA:APTAC | 1:0.75 | 50 | 42 | 4:29 |
| DMAA:APTAC | 1:1.0 | 43 | 50 | 4:08 |
| DMAA:APTAC | 0.2:1.0 | 37 | 52 | 2:24 |
| DMAA:AMPS:APTAC | 1:0.1:0.1 | 29 | 38 | |
| DMAA:APTAC:TRIS | 1:0.18:0.02 | 36 | 32 | 10:05 |
| DMAA:APTAC:TRIS | 1:0.36:0.04 | 30 | 32 | 8:54 |
| DMAA:APTAC:TRIS | 1:0.18:0.09 | 84 | 29 | 11:52 |
| DMAA:APTAC:TRIS | 1:0.36:0.02 | 55 | 31 | 9:28 |
| DMAA:APTAC:TRIS | 1:0.18:0.12 | 69 | 29 | 7:24 |
| DMAA:APTAC:TRIS | 1:0.38:0.01 | 66 | 40 | 5:02 |
| DMAA:APTAC:TRIS | 1:0.30:0.09 | 47 | 32 | 9:18 |
| DMAA:APTAC:TRIS | 1:0.5:0.09 | 65 | 39 | 5:31 |
| DMAA:APTAC:TRIS | 1:0.36:0.10 | 57 | 38 | 34 |
| DMAA:APTAC:MethylTRIS | 1:0.18:0.02 | 64 | 37 | 37 |
| DMAA:MAPTAC:TRIS | 1:0.18:0.02 | 60 | 41 | 36 |
| DMAA:APTAC:Lauryl | 1:0.18:0.02 | 42 | 60 | 1:52 |
| methacrylate | | | | |
| DMAA:TBAM:APTAC | 0.95:0.05:0.2 | 69 | 40 | 5:43 |
| DMAA:MAPTAC | 1:0.1 | 114 | 30 | 7:59 |
| DMAA:MAPTAC | 1:0.2 | 103 | 30 | 7:59 |
| DMAA:MAPTAC | 1:0.4 | | 36 | 6:56 |
| DMAA:MAETAC | 1:0.2 | 82 | 35 | 6:50 |
| DMAA:AETAC | 1:0.2 | 129 | 29 | 5:24 |
| DMAA:DADAC | 1:0.2 | 27 | DNE* | 00:54 |
| DMAA:APTAC:TRIS:Acrylamide | 1:0.18:0.09:0.09 | 144 | 26 | 12:18 |
| DMAA:APTAC:TRIS:Acrylamide | 1:0.18:0.09:0.18 | 115 | 26 | 5913:16 |
| DMAA:APTAC:TRIS:Acrylamide | 1:0.18:0.09:0.54 | 154 | 25 | 18:33 |
| DMAA:APTAC:TRIS:Acrylamide | 1:0.18:0.09:1.09 | 150 | 26 | 19:33 |
| DMAA:APTAC:TRIS:Acrylamide | 1:0.18:0.09:1.09 | 220 | 28 | 10:12 |
| (diluted to 2.7%) | | | | |
| DMAA:APTAC:TRIS:Acrylamide | 1:0.18:0.09:2.2 | 175 | | 41 |
| DMAA:APTAC:TRIS:Acrylamide | 1:0.18:0.09:2.0 | 116 | | 19:33 |
| DMAA:APTAC:TRIS:Acrylamide | 1:0.18:0.09:2.20 | 176 | | 10:12 |
| (diluted to 2.7% in conc.) | | | | |
| DMAA:APTAC:TRIS:Acrylic | 1:0.18:0.09:0.18 | 120 | 36 | 8:57 |
| Acid 13% | | | | |
| DMAA:APTAC:TRIS:Acrylic | 1:0.18:0.09:0.18 | 80 | 47 | 4:27 |
| Acid (2.7% in conc.) | | | | |
| DMAA:APTAC:TRIS:Acrylamide | 1:0.18:0.12:0.54 | 155 | 25 | 13:17 |
| DMAA:APTAC:TRIS:Methyl | 1:0.18:0.09:0.09 | 124 | 29 | 8:14 |
| Acrylate | | | | |
| DMAA:APTAC:TRIS: Methyl | 1:0.18:0.09:0.045 | 164 | 28 | 11:10 |
| Acrylate | | | | |
| DMAA:APTAC:TRIS:Na- | 1:0.18:0.09:0.4 | 74 | 34 | 2:11 |
| Acrylate (9.5% in conc.) | | | | |
| DMAA:APTAC:TRIS:Na- | 1:0.18:0.09:0.4 | 51 | 38 | 2:57 |
| Acrylate (2% in conc.) | | | | |
| DMAA:APTAC:TRIS:Na- | 1:0.18:0.09:0.18 | 43 | 58 | 1:00 |
| AMPS | | | | |
| DMAA:APTAC:TRIS:Na- | 1:0.18:0.09:0.18 | 43 | 58 | 1:00 |
| AMPS | | | | |
| DMAA:APTAC:TRIS:Glycerol | 1:0.18:0.09:0.07 | 83 | 29 | 7:40 |
| DMAA:APTAC:TRIS:N- | 1:0.18:0.09:1.09 | 150 | 28 | 14:44 |
| vinyl formamide | | | | |
| DMAA:APTAC:A174:Acrylamide | 1:0.18:0.09:1.09 | 44 | 30 | 4:18 |
| DMAA:APTAC:TRIS:AMPs:Acrylamide | 1:0.18:0.09:0.002:1.09 | 138 | 28 | 14:49 |
| DMAA:APTAC:TRIS:Glycerol:Acrylamide | 1:0.18:0.09:0.06:1.09 | 96 | 27 | 15:13 |
| DMAA:APTAC:Silmer Di- | 1:0.18:0.09:1.09 | 45 | 56 | 1:44 |
| 10:Acrylamide | | | | |
| DMAA:APTAC:Silmer Di- | 1:0.18:0.09:1.09 | 53 | 60 | 1:58 |
| 1508:Acrylamide | | | | |

* DNE - did not extinguish.

### Illustrative Embodiments

Reference is made to a number of illustrative embodiments of the subject matter described herein. The following embodiments describe illustrative embodiments that may include various features, characteristics, and advantages of the subject matter as presently described. Accordingly, the following embodiments should not be considered as being comprehensive of all of the possible embodiments or otherwise limit the scope of the methods, materials, and compositions described herein.

The present application is directed to aqueous foam compositions, typically in concentrate form, which can be diluted with an aqueous diluent to provide a foam precursor composition, which may be aerated to form a firefighting foam. A first illustrative embodiment provides an aqueous firefighting composition that includes a non-fluorinated copolymer having quaternary ammonium groups and siloxane moieties; wherein the polymer has a net cationic charge. Another illustrative embodiment provides an aqueous firefighting composition that includes a cationic copolymer, which comprises the polymerization product of a monomer mixture comprising a neutral vinyl monomer and a quaternary ammonium containing monomer.

In some embodiments, the present compositions may include a cationic copolymer containing polymerized units derived from a mixture, that includes
(i) water-soluble (meth)acrylamide monomer,
(ii) cationic monomer comprising a quaternary ammonium salt, and
(iii) optionally, a silicone-containing monomer, and
(iv) optionally, an anionic monomer containing at least one carboxylate and/or sulfonate group.

Another illustrative embodiment provides an aqueous firefighting foam composition including (a) a cationic polymer comprising polymerized units derived from a mixture comprising:
(i) water-soluble (meth)acrylamide monomer,
(ii) cationic monomer comprising a quaternary ammonium salt, and
(iii) optionally, a silicone-containing monomer, and
(iv) optionally, an anionic monomer containing at least one carboxylate and/or sulfonate group;
   (b) a surfactant component comprising anionic surfactant and nonionic surfactant;
   (c) water-miscible organic solvent comprising an alkylene glycol and/or an alkylene glycol ether; and
   (d) divalent metal cation salt, e.g., a magnesium salt, such as magnesium sulfate and/or magnesium acetate;
   where the composition is substantially free of fluorinated additives.

Another illustrative embodiment provides an aqueous firefighting foam composition including
(a) a cationic polymer comprising polymerized units derived from a mixture comprising:
   (i) water-soluble (meth)acrylamide monomer,
   (ii) cationic monomer comprising a quaternary ammonium salt, and
   (iii) optionally, a silicone-containing monomer, and
   (iv) optionally, an anionic monomer containing at least one carboxylate and/or sulfonate group;
(b) a surfactant component comprising anionic surfactant and zwitterionic surfactant; and
(c) a sugar component, e.g., a monosaccharide and/or sugar alcohol; where the composition being substantially free of fluorinated additives.

In another embodiment, the aqueous firefighting foam composition includes (a) a cationic polymer comprising polymerized units derived from a mixture comprising:
(i) water-soluble (meth)acrylamide monomer,
(ii) cationic monomer comprising a quaternary ammonium salt, and
(iii) optionally, a silicone-containing monomer, and
(iv) optionally, an anionic monomer containing at least one carboxylate and/or sulfonate group;
   (b) a surfactant component; and
   (c) a polysaccharide thickener;
   where the composition being substantially free of fluorinated additives.

In some embodiments, the present compositions may include a cationic copolymer containing polymerized units derived from a mixture, that includes
(i) water-soluble (meth)acrylamide monomer,
(ii) N-vinylformamide monomer,
(iii) cationic monomer comprising a quaternary ammonium salt, and
(iv) a silicone-containing monomer, and
(v) optionally, an anionic monomer containing at least one carboxylate and/or sulfonate group.

Another illustrative embodiment provides an aqueous firefighting foam composition including (a) a cationic polymer comprising polymerized units derived from a mixture comprising:
(i) water-soluble (meth)acrylamide monomer,
(ii) N-vinylformamide monomer,
(iii) cationic monomer comprising a quaternary ammonium salt, and
(iv) a silicone-containing monomer, and
(v) optionally, an anionic monomer containing at least one carboxylate and/or sulfonate group;
   (b) a surfactant component comprising anionic surfactant and nonionic surfactant;
   (c) water-miscible organic solvent comprising an alkylene glycol and/or an alkylene glycol ether; and
   (d) divalent metal cation salt, e.g., a magnesium salt, such as magnesium sulfate and/or magnesium acetate;
   where the composition is substantially free of fluorinated additives.

Another illustrative embodiment provides an aqueous firefighting foam composition including (a) a cationic polymer comprising polymerized units derived from a mixture comprising:
(i) water-soluble (meth)acrylamide monomer,
(ii) N-vinylformamide monomer,
(iii) cationic monomer comprising a quaternary ammonium salt, and
(iv) a silicone-containing monomer, and
(v) optionally, an anionic monomer containing at least one carboxylate and/or sulfonate group;
   (b) a surfactant component comprising anionic surfactant and zwitterionic surfactant; and
   (c) a sugar component, e.g., a monosaccharide and/or sugar alcohol;
   where the composition being substantially free of fluorinated additives.

In another embodiment, the aqueous firefighting foam composition includes (a) a cationic polymer comprising polymerized units derived from a mixture comprising:
(i) water-soluble (meth)acrylamide monomer,
(ii) N-vinylformamide monomer,
(iii) cationic monomer comprising a quaternary ammonium salt, and
(iv) a silicone-containing monomer, and
(v) optionally, an anionic monomer containing at least one carboxylate and/or sulfonate group;
   (b) a surfactant component; and
   (c) a polysaccharide thickener;

where the composition being substantially free of fluorinated additives.

In the illustrative embodiments described in this section, the aqueous firefighting composition may suitably include: a) nonionic surfactant; b) anionic surfactant; and c) water-miscible organic solvent. For example, the aqueous firefighting composition may suitably include: a) alkyl polysaccharide and/or aliphatic alcohol-based surfactant; b) alkyl sulfate and/or alkyl ether sulfate surfactant; and c) water-miscible organic solvent comprising an alkylene glycol and/or an alkylene glycol ether. Such an aqueous firefighting composition may also include a polysaccharide thickener and a sugar component.

In the illustrative embodiments described in this section, the aqueous firefighting composition may suitably include: a) anionic surfactant; b) zwitterionic surfactant; and c) water-miscible organic solvent. For example, the aqueous firefighting composition may suitably include: a) alkyl sulfate and/or alkyl ether sulfate surfactant; b) alkylamidoalkyl hydroxysultaine surfactant and/or alkyl betaine surfactant; and c) water-miscible organic solvent comprising an alkylene glycol and/or an alkylene glycol ether. Quite often, such an aqueous firefighting composition may also include a polysaccharide thickener and a sugar component.

In the illustrative embodiments described in this section, the aqueous firefighting composition may suitably include: a) nonionic surfactant; b) zwitterionic surfactant; c) anionic surfactant; and d) water-miscible organic solvent. For example, the aqueous firefighting composition may suitably include: a) alkyl sulfate and/or alkyl ether sulfate surfactant; b) alkylamidoalkyl hydroxysultaine surfactant and/or alkyl betaine surfactant; c) an aliphatic alcohol-based component (e.g., an aliphatic alcohol and/or an aliphatic alcohol ethoxylate) and/or an alkyl polyglucoside as a nonionic surfactant; and d) water-miscible organic solvent comprising an alkylene glycol and/or an alkylene glycol ether. Quite often, such an aqueous firefighting composition may also include a polysaccharide thickener and a sugar component.

In many instances the aqueous firefighting compositions described in this section may also include one or more additional additives, such as a preservative, a corrosion inhibitor, and/or a pH adjusting agent. In many instances, the firefighting compositions include a pH adjusting agent, such as an alkanolamine.

Another illustrative embodiment provides a method of fighting a fire, including forming a foam from a composition that includes at least one of the aqueous firefighting foam compositions previously disclosed herein, and applying the foam directly or indirectly onto the fire. Such a method may be employed to fight a class A or class B fire.

Another illustrative embodiment provides a method of forming a firefighting foam including diluting the composition of any of the aqueous firefighting foam compositions previously disclosed herein with an aqueous diluting agent to provide a foam precursor solution, and aerating the foam precursor solution to provide the firefighting foam. The aqueous diluting agent may include one or more of municipal water, brackish water and salt water

Another illustrative embodiment provides a non-fluorinated copolymer having quaternary ammonium groups and siloxane moieties; wherein the copolymer has a net cationic charge. Such a copolymer may be the polymerization product of a monomer mixture comprising a neutral vinyl monomer and a quaternary ammonium containing monomer. The neutral vinyl monomer may include a (meth)acrylamide monomer, an N-vinylformamide monomer and/or (meth)acrylate monomer. Suitable (meth)acrylamide monomers include one or more of an N,N-dialkyl acrylamide, an N-alkyl acrylamide, an N,N-dialkyl methacrylamide, an N-alkyl methacrylamide and acrylamide. Suitable (meth)acrylate monomers include one or more of an alkyl acrylate, an alkyl methacrylate, a dialkylaminoalkyl acrylate and a dialkylaminoalkyl methacrylate. The quaternary ammonium containing monomer may include a quaternary ammonium substituted (meth)acrylamide monomer and/or a quaternary ammonium substituted (meth)acrylate monomer and/or a quaternary ammonium substituted allyl monomer. Suitable quaternary ammonium substituted monomers include one or more of an (acrylamidoalkyl)trialkylammonium salt, a (methacrylamidoalkyl)trialkylammonium salt, a (methacryloyloxyalkyl)trialkylammonium salt and a (acryloyloxyalkyl)trialkylammonium salt. The monomer mixture also includes a siloxane substituted monomer, such as a siloxane substituted vinyl monomer. Suitable siloxane substituted vinyl monomers include siloxane substituted (meth)acrylate monomers and/or a siloxane substituted (meth)acrylamide monomers. The monomer mixture may also include an anionic monomer, such as an anionic vinyl monomer. The anionic vinyl monomer may suitably include a vinyl monomer having one or more carboxylic acid and/or sulfonic acid groups or salts thereof.

Various embodiments are described herein. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). While certain embodiments have been illustrated and described, it should be understood that changes and modifications can be made therein in accordance with ordinary skill in the art without departing from the technology in its broader aspects.

Features may be described herein as part of the same or separate aspects or embodiments of the present technology for the purpose of clarity and a concise description. It will be appreciated by the skilled person that the scope of the present technology may include embodiments having combinations of all or some of the features described herein as part of the same or separate embodiments.

All percentages specified herein represent percent by weight unless otherwise indicated.

“Alkyl” refers to monovalent saturated aliphatic hydrocarbyl groups having from 1 to 14 carbon atoms, preferably 1 to 12 carbon atoms and more preferably 1 to 6 carbon atoms (“lower alkyl”). Higher carbon atom containing alkyl groups are also contemplated in certain embodiments, as the context will indicate. This term includes, by way of example, linear and branched hydrocarbyl groups such as methyl (CH3-), ethyl (CH3CH2), -n-propyl-(CH3CH2CH2-), isopropyl ((CH3)2CH), -n-butyl-(CH3CH2CH2CH2-), isobutyl ((CH3)2CHCH2-), sec-butyl ((CH3)(CH3CH2) CH), -t-butyl-((CH3)3C), -n-pentyl-(CH3CH2CH2CH2CH2-), and neopentyl ((CH3)3CCH2-). The alkyl group may be optionally substituted by 1 to 5, preferably 1 to 3, or more preferably 1 to 2 substituents selected from the group consisting of alkoxy, acyl, acylamino, acyloxy, amino, aryl, aryloxy, carboxyl, cyano, and cycloalkyl groups.

“Aryl” refers to an aromatic carbocyclic group of from 6 to 14 carbon atoms having a single ring (e.g., phenyl) or multiple condensed rings (e.g., naphthyl or anthryl) which condensed rings may or may not be aromatic (e.g., 2-benzoxazolinone, 2H-1,4-benzoxazin-3(4H)-one-7-yl, and the like) provided that the point of attachment is at an aromatic carbon atom. The aryl group may be optionally substituted by 1 to 5, preferably 1 to 3, or more preferably 1 to 2 substituents selected from the group consisting of alkyl, alkoxy, acyl, acylamino, acyloxy, amino, carboxyl, cyano, and cycloalkyl groups.

(Meth) acryl-as mentioned herein includes both acryl-as well as methacryl-groups. Thus, for example, (meth)acrylamide encompasses acrylamide as well as methacrylamide, and (meth)acrylate includes both acrylate and methacrylate.

The embodiments illustratively described herein may suitably be practiced in the absence of any element or elements, limitation or limitations, not specifically disclosed herein. Thus, for example, the terms “comprising,” “including,” “containing,” shall be read expansively and without limitation. Additionally, the terms and expressions employed herein have been used as terms of description and not of limitation, and there is no intention in the use of such terms and expression of excluding any equivalents of the features shown and described or potions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, the term “and/or” includes any and all combinations of one or more of the associated listed items.

The use of the terms “a” and “and” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Additionally, where features or aspects of the disclosure are described in terms of Markush groups, those skilled in the art will realize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof.

1. An aqueous firefighting composition comprising a non-fluorinated copolymer having quaternary ammonium groups and siloxane moieties; wherein the polymer has a net cationic charge.

2. The aqueous firefighting composition of claim 1, wherein the copolymer comprises the polymerization product of a monomer mixture comprising a neutral vinyl monomer and a quaternary ammonium containing monomer.

3. The aqueous firefighting composition of claim 2, wherein neutral vinyl monomer comprises a (meth)acrylamide monomer, an N-vinylformamide monomer, and/or (meth)acrylate monomer.

4. The aqueous firefighting composition of claim 3, wherein the (meth)acrylamide monomer comprises one or more of an N,N-dialkyl acrylamide, an N-alkyl acrylamide, an N,N-dialkyl methacrylamide, an N-alkyl methacrylamide, and acrylamide.

5. (canceled)

6. The aqueous firefighting composition of claim 3, wherein the (meth)acrylate monomer comprises one or more of an alkyl acrylate, an alkyl methacrylate, a dialkylaminoalkyl acrylate, and a dialkylaminoalkyl methacrylate.

7. (canceled)

8. The aqueous firefighting composition of claim 2, wherein the quaternary ammonium containing monomer comprises a quaternary ammonium substituted (meth)acrylamide monomer and/or a quaternary ammonium substituted (meth)acrylate monomer and/or a quaternary ammonium substituted allyl monomer.

9. The aqueous firefighting composition of claim 8, wherein the quaternary ammonium substituted (meth)acrylamide monomer and/or quaternary ammonium substituted (meth)acrylate monomer comprises one or more of an (acrylamidoalkyl)trialkylammonium salt, a (methacrylamidoalkyl)trialkylammonium salt, an (acryloyloxyalkyl)trialkylammonium salt, and a (methacryloyloxyalkyl)trialkylammonium salt.

10. The aqueous firefighting composition of claim 8, wherein the quaternary ammonium substituted (meth)acrylamide monomer and/or quaternary ammonium substituted (meth)acrylate monomer comprises one or more of (3-acrylamidopropyl)trimethylammonium chloride (APTAC), (3-methacrylamidopropyl)trimethylammonium chloride (MAPTAC), [2-(acryloyloxy)ethyl]trimethylammonium chloride (AETAC), and [3-(methacryloyloxy)-propyl]trimethylammonium chloride (MAETAC).

11. The aqueous firefighting composition of claim 2, wherein monomer mixture comprises a siloxane substituted vinyl monomer.

12. The aqueous firefighting composition of claim 11, wherein the siloxane substituted vinyl monomer comprises a siloxane substituted (meth)acrylate monomer and/or a siloxane substituted (meth)acrylamide monomer.

13. The aqueous firefighting composition of claim 11, wherein the siloxane substituted (meth)acrylate monomer and/or a siloxane substituted (meth)acrylamide monomer comprises one or more of 3-[tris(trimethylsiloxy)silyl]propyl methacrylate, 3-trimethoxysilylpropyl 2-methylprop-2-enoate, 3-[tris(trimethylsiloxy)silyl]propyl acrylate, N-[tris(trimethylsiloxy) silylpropyl]-(meth)acrylamide, N-[tris(dimethylpropylsiloxy)-silylpropyl](meth)acrylamide, N-[tris(dimethylphenylsiloxy)-silylpropyl](meth)acrylamide, and N-[tris(dimethylethylsiloxy) silylpropyl](meth)acrylamide.

14. The aqueous firefighting composition of claim 2, wherein the monomer mixture further comprises an anionic vinyl monomer.

15. The aqueous firefighting composition of claim 14, wherein the anionic vinyl monomer comprises one or more of acrylic acid, sodium methacrylate, methacrylic acid, sodium methacrylate, potassium 3-sulfopropyl acrylate, sodium 3-sulfopropyl methacrylate, 2-acrylamido-2-methyl-1-propanesulfonic acid, potassium 2-acrylamido-2-methyl-1-propanesulfonate (K-AMPS), 2-methacrylamido-2-methyl-1-propanesulfonic acid sodium salt, and 2-acrylamido-2-methyl-1-propanesulfonic acid sodium salt (Na-AMPS).

16. The aqueous firefighting composition of claim 14, wherein the anionic vinyl monomer comprises a vinyl monomer having one or more carboxylic acid and/or sulfonic acid groups or salts thereof.

17. (canceled)

18. The aqueous firefighting composition of claim 1, further comprising:
an alkyl polysaccharide, an aliphatic alcohol-based surfactant, or both;
an alkyl sulfate, an alkyl ether sulfate surfactant, or both; and
a water-miscible organic solvent comprising an alkylene glycol, an alkylene glycol ether, or both.

19. The aqueous firefighting composition of claim 1, further comprising:
an anionic surfactant;
a zwitterionic surfactant; and
a water-miscible organic solvent.

20. The aqueous firefighting composition of claim 1, further comprising:
an alkyl sulfate and/or alkyl ether sulfate surfactant;
an alkylamidoalkyl hydroxysultaine surfactant and/or alkyl betaine surfactant; and
a water-miscible organic solvent comprising an alkylene glycol and/or an alkylene glycol ether.

21. (canceled)

22. The aqueous firefighting composition of claim 1 further comprising a polysaccharide thickener a sugar component, or a mixture of any two or more thereof.

23. (canceled)

24. The aqueous firefighting composition of claim 1 further comprising divalent metal salt, a preservative, a corrosion inhibitor, a pH adjusting agent, or a mixture of any two or more thereof.

25. (canceled)

26. The aqueous firefighting composition of claim 1 further comprising an alkanolamine.

27-52. (canceled)
